(19) United States
(12) Patent Application Publication
(10) Pub. No.: US 2013/0085712 A1
(43) Pub. Date: Apr. 4, 2013

(54) INERTIAL SENSING INPUT APPARATUS AND METHOD THEREOF

(71) Applicants: Chia-Yu WANG, Tainan City (TW); Ching-Hsiang TU, Kaohsiung City (TW); Chih-Tsung CHIANG, Tainan City (TW); Chih-Kai CHIU, Tainan City (TW)

(72) Inventors: Chia-Yu WANG, Tainan City (TW); Ching-Hsiang TU, Kaohsiung City (TW); Chih-Tsung CHIANG, Tainan City (TW); Chih-Kai CHIU, Tainan City (TW)

(73) Assignee: INDUSTRIAL TECHNOLOGY RESEARCH INSTITUTE, Hsinchu (TW)

(21) Appl. No.: 13/406,799

(22) Filed: Feb. 28, 2012

(30) Foreign Application Priority Data
Sep. 30, 2011 (TW) 100135640

(51) Int. Cl. G06F 15/00

(52) U.S. Cl. 702/141

(57) ABSTRACT

An inertial sensing input apparatus includes a motion sensing module, a state determination module, an attitude estimation module, a coordinate transformation module, a gravity elimination module, an integral operation module, a data storage module, a trajectory modification module and a trajectory removal module. When the inertial sensing input apparatus is in a moving time period, the coordinate transformation module transforms a relative acceleration measured by the motion sensing module to an absolute acceleration based on a rotational attitude estimated by the attitude estimation module. The integral operation module calculates a velocity and a displacement based on an absolute acceleration revised by the gravity elimination module and forwards them to the data storage module. When the K^{th} moving time period is detected by the state determination module, the trajectory modification module modifies a moving trajectory. The trajectory removal module removes an auxiliary trajectory to produce a primary trajectory.

### CROSS-REFERENCE TO RELATED APPLICATIONS

This non-provisional application claims priority under 35 U.S.C. §119(a) on Patent Application No(s). 100135640 filed in Taiwan, R.O.C. on Sep. 30, 2011, the entire contents of which are hereby incorporated by reference.

### BACKGROUND

1. Technical Field

The present disclosure relates to an inertial sensing input apparatus and method thereof, and in particular, to an inertial sensing input apparatus and method thereof which can be applied in three-dimensional space.

2. Related Art

Generally, there are many types of input devices for computer products, communication products and consumer electronics products, the most common ones are keyboards, mice and touch panels. These input devices are mostly used in two-dimensional planes.

In recent years, with the rapid development of technology industry, different types of products focus on getting smaller and smaller in size. Inertial sensing devices such as an accelerometer and a gyroscope are also evolved with miniature size, and the inertial sensing devices can be integrated in portable input devices, so the portable input devices can perform measurement and input functions without connection to additional sensing components. Furthermore, tri-axial inertial sensing devices can be used in three-dimensional space to perform measurement.

However, in conventional small sized inertial sensing devices, the method for computing moving trajectories by measured acceleration can easily result in divergence in the moving trajectories because errors in acceleration measurement exaggerate after double integral computation. When the portable input devices equipped with the conventional small sized inertial sensing devices are applied in the computer products, the communication products or the consumer electronic products with character writing as input data, it is possible that graphic or character input via the portable input devices can not be displayed or recognized correctly due to divergence in computation of the moving trajectory. Therefore, for the conventional small sized inertial sensing devices, there is certain difficulty in obtaining correct moving trajectories.

### SUMMARY

In order to solve the problem of the divergence of moving trajectory due to double integral calculation of the imprecise acceleration measurement in existing techniques, the present disclosure discloses an inertial sensing input apparatus and method thereof.

According to an embodiment of an inertial sensing input apparatus disclosed in the present disclosure, the inertial sensing input apparatus includes a motion sensing module, a state determination module, an attitude estimation module, a coordinate transformation module, a gravity elimination module, an integral operation module, a data storage module and a trajectory modification module. The motion sensing module measures a motion signal of the inertial sensing input apparatus, and the motion signal includes a relative acceleration of the inertial sensing input apparatus. The state determination module compares a variation in the motion signal with a preset value, in order to determine if the inertial sensing input apparatus is in a stationary state or in a moving state, and to detect at least one moving time period of the inertial sensing input apparatus, and a first instant and a second instant in the detected moving time period. The moving time period is from a time instant when the inertial sensing input apparatus changes from a stationary state to a moving state, to another time instant when the inertial sensing input apparatus changes from the moving state to the stationary state. The time instant from the stationary state to the moving state is the first instant, and the time instant from the moving state to the stationary state is the second instant.

When the inertial sensing input apparatus is in the moving time period, the attitude estimation module estimates a rotational attitude of the inertial sensing input apparatus based on the motion signal in the moving time period. The coordinate transformation module transforms the relative acceleration in the moving time period to an absolute acceleration based on the rotational attitude of the moving time period. The gravity elimination module eliminates the gravitation effect from the absolute acceleration in the moving time period. The integral operation module calculates a velocity and a displacement of the inertial sensing input apparatus in the moving time period based on the gravity-eliminated absolute acceleration, the first instant and the second instant in the moving time period. The data storage module stores the first instant, the second instant, the velocity and the displacement of the inertial sensing input apparatus in the moving time period. When the state determination module detects the second instant in the K^{th} moving time period, the data storage module outputs the K first instants, the K second instants, the K velocities and the K displacements in the K moving time periods to the trajectory modification module. The trajectory modification module calculates a moving trajectory of the inertial sensing input apparatus in the K moving time periods based on the K first instants, the K second instants, the K velocities and the K displacements, and performs a nonlinear modification. K is a preset positive integer (K is a set value and K is an integer larger than one or equal to one), an N^{th} degree equation is used in the nonlinear modification onto the moving trajectory, and N is an integer larger than two.

According to an embodiment of an inertial sensing input apparatus disclosed in the present disclosure, the inertial sensing input apparatus includes a motion sensing module, a state determination module, an attitude estimation module, a coordinate transformation module, a gravity elimination module, an integral operation module, a data storage module, a trajectory modification module and a trajectory removal module. The motion sensing module measures a motion signal of the inertial sensing input apparatus, and the motion signal includes a relative acceleration of the inertial sensing input apparatus. The state determination module compares a variation in the motion signal with a preset value, in order to determine if the inertial sensing input apparatus is in a stationary state or in a moving state, and to detect at least two moving time periods of the inertial sensing input apparatus, and a first instant and a second instant in each of the moving time periods detected. Each of the moving time periods is from the first instant when the inertial sensing input apparatus changes from the stationary state to the moving state, to the second instant when the inertial sensing input apparatus changes from the moving state to the stationary state.

When the inertial sensing input apparatus is in each of the moving time periods, the attitude estimation module estimates a rotational attitude of the inertial sensing input apparatus based on the motion signal in each of the moving time periods. The coordinate transformation module transforms the relative acceleration in each of the moving time periods to an absolute acceleration based on the rotational attitude in each of the moving time periods. The gravity elimination module eliminates the gravitation effect from the absolute acceleration in each of the moving time periods. The integral operation module calculates a velocity and a displacement of the inertial sensing input apparatus in each of the moving time periods based on the gravity-eliminated absolute acceleration, the first instant and the second instant in each of the moving time periods. The data storage module stores the first instant, the second instant, the velocity and the displacement of the inertial sensing input apparatus in each of the moving time periods. When the state determination module has detected the second instant in the K^{th} moving time period, the data storage module outputs the K first instants, the K second instants, the K velocities and the K displacements in the K moving time periods to the trajectory modification module. The trajectory modification module calculates a moving trajectory of the inertial sensing input apparatus in the K moving time periods based on the K first instants, the K second instants, the K velocities and the K displacements, and performs a modification procedure onto the moving trajectory. K is a set value and is an integer larger than two or equal to two. The trajectory removal module removes an auxiliary trajectory in the K^{th} moving time period from the modified moving trajectory in order to produce a primary trajectory.

According to an embodiment of an inertial sensing input apparatus disclosed in the present disclosure, the inertial sensing input apparatus includes a motion sensing module, a state determination module, a data storage module, an attitude estimation module, a coordinate transformation module, a gravity elimination module, an integral operation module and a trajectory modification module. The motion sensing module measures a motion signal of the inertial sensing input apparatus, and the motion signal includes a relative acceleration of the inertial sensing input apparatus. The state determination module compares a variation in the motion signal with a preset value, in order to determine if the inertial sensing input apparatus is in a stationary state or in a moving state, and to detect at least one moving time period of the inertial sensing input apparatus, and a first instant and a second instant of the moving time period detected. The moving time period is from the first instant when the inertial sensing input apparatus changes from the stationary state to the moving state, to the second instant when the inertial sensing input apparatus changes from the moving state to the stationary state. When the inertial sensing input apparatus is in the moving time period, the data storage module stores the first instant, the second instant and the motion signal of the inertial sensing input apparatus in the moving time period.

When the state determination module detects the second instant of the K^{th} moving time period, the data storage module outputs the K first instants, the K second instants and the K motion signals to the attitude estimation module. The attitude estimation module estimates a rotational attitude of the inertial sensing input apparatus based on the motion signal in each of the moving time periods, K is a preset positive integer (K is a set value and K is an integer larger than one or equal to one). The coordinate transformation module transforms the K relative accelerations to K absolute accelerations based on the K rotational attitudes. The gravity elimination module eliminates the gravitation effect from the K absolute accelerations. The integral operation module calculates a velocity and a displacement of the inertial sensing input apparatus in each of the moving time periods based on the K gravity-eliminated absolute accelerations, the K first instants and the K second instants. The trajectory modification module calculates a moving trajectory of the inertial sensing input apparatus in the K moving time periods based on the K first instants, the K second instants, the K velocities and the K displacements, and performs a nonlinear modification. An N^{th} degree equation is used in the nonlinear modification onto the moving trajectory, and N is an integer larger than two.

According to an embodiment of an inertial sensing input apparatus disclosed in the present disclosure, the inertial sensing input apparatus includes a motion sensing module, a state determination module, a data storage module, an attitude estimation module, a coordinate transformation module, a gravity elimination module, an integral operation module, a trajectory modification module and a trajectory removal module. The motion sensing module measures a motion signal of the inertial sensing input apparatus, and the motion signal includes a relative acceleration of the inertial sensing input apparatus. The state determination module compares a variation in the motion signal with a preset value, in order to determine if the inertial sensing input apparatus is in a stationary state or in a moving state, and to detect at least two moving time periods of the inertial sensing input apparatus, and a first instant and a second instant in each of the moving time periods detected. Each of the moving time periods is from the first instant when the inertial sensing input apparatus changes from the stationary state to the moving state, to the second instant when the inertial sensing input apparatus changes from the moving state to the stationary state.

When the inertial sensing input apparatus is in each of the moving time periods, the data storage module stores the first instant, the second instant and the motion signal of the inertial sensing input apparatus in each of the moving time periods. When the state determination module has detected the second instant in the K^{th} moving time period, the data storage module outputs the K motion signals to the attitude estimation module. The attitude estimation module estimates K rotational attitudes of the inertial sensing input apparatus based on the K motion signals in the K moving time periods, K is a set value and is an integer larger than two or equal to two. The coordinate transformation module transforms the K relative accelerations to K absolute accelerations based on the K rotational attitudes. The gravity elimination module eliminates the gravitation effect from the K absolute accelerations. The integral operation module calculates a velocity and a displacement of the inertial sensing input apparatus in each of the moving time periods based on the K gravity-eliminated absolute accelerations, the K first instants and the K second instants. The trajectory modification module calculates a moving trajectory of the inertial sensing input apparatus in the K moving time periods based on the K first instants, the K second instants, the K velocities and the K displacements, and performs a modification procedure onto the moving trajectory. The trajectory removal module removes an auxiliary trajectory of the K^{th} moving time period from the modified moving trajectory in order to produce a primary trajectory.

According to an embodiment of an inertial sensing input method disclosed in the present disclosure, the inertial sensing input method includes measuring a motion signal of an inertial sensing input apparatus by a motion sensing module, and the motion signal includes a relative acceleration of the inertial sensing input apparatus. Comparing a variation in the motion signal with a preset value by a state determination module, in order to determine if the inertial sensing input apparatus is in a stationary state or in a moving state, and to detect at least one moving time period of the inertial sensing input apparatus, and a first instant and a second instant of the moving time period detected. The moving time period is from the first instant when the inertial sensing input apparatus changes from the stationary state to the moving state, to the second instant when the inertial sensing input apparatus changes from the moving state to the stationary state. When the inertial sensing input apparatus is in the moving time period, estimating a rotational attitude of the inertial sensing input apparatus based on a motion signal in the moving time period by an attitude estimation module. Transforming the relative acceleration in the moving time period to an absolute acceleration based on the rotational attitude in the moving time period by a coordinate transformation module. Eliminating the gravitation effect from the absolute acceleration in the moving time period by a gravity elimination module.

Calculating a velocity and a displacement of the inertial sensing input apparatus in the moving time period based on the absolute acceleration, the first instant and the second instant of the moving time period by an integral operation module. Storing the first instant, the second instant, the velocity and the displacement of the inertial sensing input apparatus in the moving time period by a data storage module. When the state determination module detects the second instant in the K^{th} moving time period, outputting the K first instants, the K second instants, the K velocities and the K displacements of the K moving time periods to a trajectory modification module by the data storage module. Calculating a moving trajectory of the inertial sensing input apparatus in the K moving time periods based on the K first instants, the K second instants, the K velocities and the K displacements by the trajectory modification module, and performing a nonlinear modification. K is a preset positive integer (K is a set value and K is an integer larger than one or equal to one), an N^{th} degree equation is used in the nonlinear modification onto the moving trajectory, and N is an integer larger than two.

According to an embodiment of an inertial sensing input method disclosed in the present disclosure, the inertial sensing input method includes measuring a motion signal of an inertial sensing input apparatus by a motion sensing module, and the motion signal includes a relative acceleration of the inertial sensing input apparatus. Comparing a variation in the motion signal with a preset value by a state determination module, in order to determine if the inertial sensing input apparatus is in a stationary state or in a moving state, and to detect at least two moving time periods of the inertial sensing input apparatus, and a first instant and a second instant in each of the moving time periods detected. Each of the moving time periods is from the first instant when the inertial sensing input apparatus changes from the stationary state to the moving state, to the second instant when the inertial sensing input apparatus changes from the moving state to the stationary state. When the inertial sensing input apparatus is in each of the moving time periods, estimating a rotational attitude of the inertial sensing input apparatus based on the motion signal in each of the moving time periods by an attitude estimation module.

Transforming the relative acceleration of each of the moving time periods to an absolute acceleration based on the rotational attitude of each of the moving time periods by a coordinate transformation module. Eliminating the gravitation effect from the absolute acceleration in each of the moving time periods by a gravity elimination module. Calculating a velocity and a displacement of the inertial sensing input apparatus in each of the moving time periods based on the absolute acceleration, the first instant and the second instant in each of the moving time periods by an integral operation module. Storing the first instant, the second instant, the velocity and the displacement of the inertial sensing input apparatus in each of the moving time periods by a data storage module. When the state determination module detects the second instant of the K^{th} moving time period, outputting the K first instants, the K second instants, the K velocities and the K displacements of the K moving time periods to a trajectory modification module by the data storage module. Calculating a moving trajectory of the inertial sensing input apparatus in the K moving time periods based on the K first instants, the K second instants, the K velocities and the K displacements by the trajectory modification module, and performing a modification procedure onto the moving trajectory. K is a set value and is an integer larger than two or equal to two. Removing an auxiliary trajectory in the K^{th} moving time period from the modified moving trajectory by a trajectory removal module in order to produce a primary trajectory.

According to an embodiment of an inertial sensing input method disclosed in the present disclosure, the inertial sensing input method includes measuring a motion signal of an inertial sensing input apparatus by a motion sensing module, and the motion signal includes a relative acceleration of the inertial sensing input apparatus. Comparing a variation in the motion signal with a preset value by a state determination module, in order to determine if the inertial sensing input apparatus is in a stationary state or in a moving state, and to detect at least one moving time period of the inertial sensing input apparatus, and a first instant and a second instant of the moving time period detected. The moving time period is from the first instant when the inertial sensing input apparatus changes from the stationary state to the moving state, to the second instant when the inertial sensing input apparatus changes from the moving state to the stationary state, K is a preset positive integer (K is a set value and K is an integer larger than one or equal to one). When the inertial sensing input apparatus is in the moving time period, storing the first instant, the second instant, and the motion signal of the inertial sensing input apparatus in the moving time period by a data storage module. When the state determination module detects the second instant in the K^{th} moving time period, outputting the K motion signals to an attitude estimation module by the data storage module. Estimating a rotational attitude of the inertial sensing input apparatus based on the motion signal in each of the moving time periods by the attitude estimation module.

Transforming the K relative accelerations to K absolute accelerations based on the K rotational attitudes by a coordinate transformation module. Eliminating the gravitation effect from the K absolute accelerations by a gravity elimination module. Calculating a velocity and a displacement of the inertial sensing input apparatus in each of the moving time periods based on the gravity-eliminated K absolute accelerations, the K first instants and the K second instants in the K moving time periods by an integral operation module. Calculating a moving trajectory of the inertial sensing input apparatus in the K moving time periods based on the K first instants, the K second instants, the K velocities and the K displacements by a trajectory modification module, and performing a nonlinear modification. An N^{th} degree equation is used in the nonlinear modification onto the moving trajectory, and N is an integer larger than two.

According to an embodiment of an inertial sensing input method disclosed in the present disclosure, the inertial sensing input method includes measuring a motion signal of an inertial sensing input apparatus by a motion sensing module, and the motion signal includes a relative acceleration of the inertial sensing input apparatus. Comparing a variation in the motion signal with a preset value by a state determination module, in order to determine if the inertial sensing input apparatus is in a stationary state or in a moving state, and to detect at least two moving time periods of the inertial sensing input apparatus, and a first instant and a second instant in each of the moving time periods detected. Each of the moving time periods is from the first instant when the inertial sensing input apparatus changes from the stationary state to the moving state, to the second instant when the inertial sensing input apparatus changes from the moving state to the stationary state, When the inertial sensing input apparatus is in each of the moving time periods, storing the first instant, the second instant, and the motion signal of the inertial sensing input apparatus in each of the moving time periods by a data storage module. When the state determination module detects the second instant in the K^{th} moving time period, outputting the K motion signals to an attitude estimation module by the data storage module. Estimating a rotational attitude of the inertial sensing input apparatus based on the motion signal of each of the moving time periods by the attitude estimation module, K is a set value and is an integer larger than two or equal to two.

Transforming the K relative accelerations to K absolute accelerations based on the K rotational attitudes by a coordinate transformation module. Eliminating the gravitation effect from the K absolute accelerations by a gravity elimination module. Calculating a velocity and a displacement of the inertial sensing input apparatus in each of the moving time periods based on the gravity-eliminated K absolute accelerations, the K first instants and the K second instants in the K moving time periods by an integral operation module. Calculating a moving trajectory of the inertial sensing input apparatus in the K moving time periods based on the K first instants, the K second instants, the K velocities and the K displacements by a trajectory modification module, and performing a modification procedure onto the moving trajectory. Removing an auxiliary trajectory in the K^{th} moving time period from the modified moving trajectory by a trajectory removal module in order to produce a primary trajectory.

In an embodiment of an inertial sensing input apparatus and method thereof, the motion signal further includes an angular velocity of the inertial sensing input apparatus.

In an embodiment of an inertial sensing input apparatus and method thereof, the motion signal further includes a magnetic field of the inertial sensing input apparatus.

In an embodiment of an inertial sensing input apparatus and method thereof, when the state determination module detects the second instant in the K^{th} moving time period, the inertial sensing input apparatus is located at a finishing position near or the same as a starting position or a preset finishing position other than the starting position.

According to an inertial sensing input apparatus and method thereof disclosed in the present disclosure, by a setting of the inertial sensing input apparatus located at a finishing position near or the same as a starting position or a preset finishing position other than the starting position in the second instant of the K^{th} moving time period, to modify the moving trajectory calculated by the velocity and the displacement in each of the moving time periods, in order to produce a moving trajectory with a higher precision. By a setting of the trajectory removal module, redundant auxiliary trajectories can be separated and removed in order to produce a primary trajectory with a higher precision.

The structure and the technical means adopted by the present invention to achieve the above and other objects can be best understood by referring to the following detailed description of the preferred embodiments and the accompanying drawings.

### BRIEF DESCRIPTION OF THE DRAWINGS

The present disclosure will become more fully understood from the detailed description given herein below for illustration only, and thus are not limitative of the present disclosure, and wherein:

FIG. 1 is a perspective view of a structure of an inertial sensing input apparatus being applied in a digital pen according to the present disclosure;

FIG. 2 is a structural block diagram of a first embodiment according to the inertial sensing input apparatus in FIG. 1;

FIG. 3A is a flowchart of an inertial sensing input method according to an embodiment of the inertial sensing input apparatus in FIG. 2;

FIG. 3B is a flowchart of an inertial sensing input method according to an embodiment of the inertial sensing input apparatus in FIG. 2;

FIG. 4 is a structural block diagram of a second embodiment according to the inertial sensing input apparatus in FIG. 1;

FIG. 5A is a flowchart of an inertial sensing input method according to an embodiment of the inertial sensing input apparatus in FIG. 4;

FIG. 5B is a flowchart of an inertial sensing input method according to an embodiment of the inertial sensing input apparatus in FIG. 4;

FIG. 6 is a structural block diagram of a third embodiment according to the inertial sensing input apparatus in FIG. 1;

FIG. 7A is a flowchart of an inertial sensing input method according to an embodiment of the inertial sensing input apparatus in FIG. 6;

FIG. 7B is a flowchart of an inertial sensing input method according to an embodiment of the inertial sensing input apparatus in FIG. 6;

FIG. 8 is a structural block diagram of a fourth embodiment according to the inertial sensing input apparatus in FIG. 1;

FIG. 9A is a flowchart of an inertial sensing input method according to an embodiment of the inertial sensing input apparatus in FIG. 8;

FIG. 9B is a flowchart of an inertial sensing input method according to an embodiment of the inertial sensing input apparatus in FIG. 8;

FIG. 10 is a structural block diagram of an embodiment of the inertial sensing input apparatus according to the present disclosure being applied in a navigation device;

FIG. 11A is a schematic diagram of a primary trajectory of number “0”;

FIG. 11B is a schematic diagram of a primary trajectory and an auxiliary trajectory of number “0”;

FIG. 12A is a schematic diagram of a primary trajectory of number “2”; and

FIG. 12B is a schematic diagram of a primary trajectory and an auxiliary trajectory of number “2”.

### DETAILED DESCRIPTION

An inertial sensing input apparatus and method thereof disclosed in the present disclosure can be applied in portable devices for three dimensional space input such as digital pens, mobile phones, remote controllers or presenters. For convenience of description, an embodiment of the inertial sensing input apparatus and method thereof for application in digital pens is used as an example, but the below embodiment should not be construed as a limitation to the disclosure thereof.

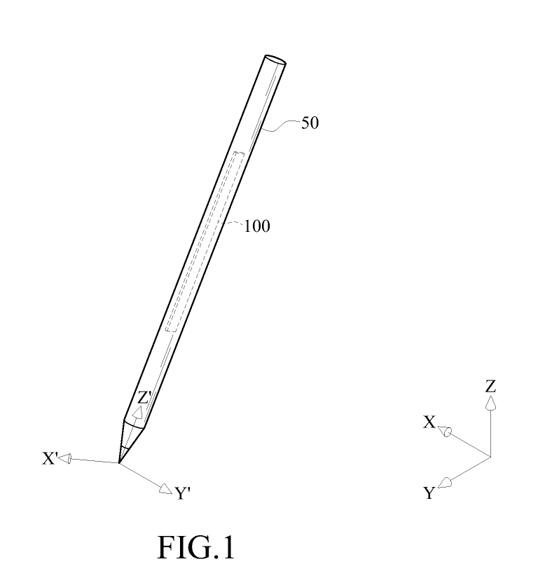

Referring to FIG. 1, FIG. 1 is a perspective view of an inertial sensing input apparatus for application in a digital pen according to the present invention. In this embodiment, the inertial sensing input apparatus 100 can be applied in a wireless pen 50, the wireless pen 50 has a relative coordinate system composed of a X′ direction, a Y′ direction and a Z′ direction, and the relative coordinate system uses a tip of the digital pen 50 as an original reference point. The digital pen 50 has an absolute coordinate system composed of a X direction, a Y direction and a Z direction in a three dimensional space, a fixed position (e.g. any point in space) is used as a fixed original point for an absolute coordinate. Wherein the X′ direction, the Y′ direction and the Z′ direction are perpendicular to each other, the X direction, the Y direction and the Z direction are perpendicular to each other.

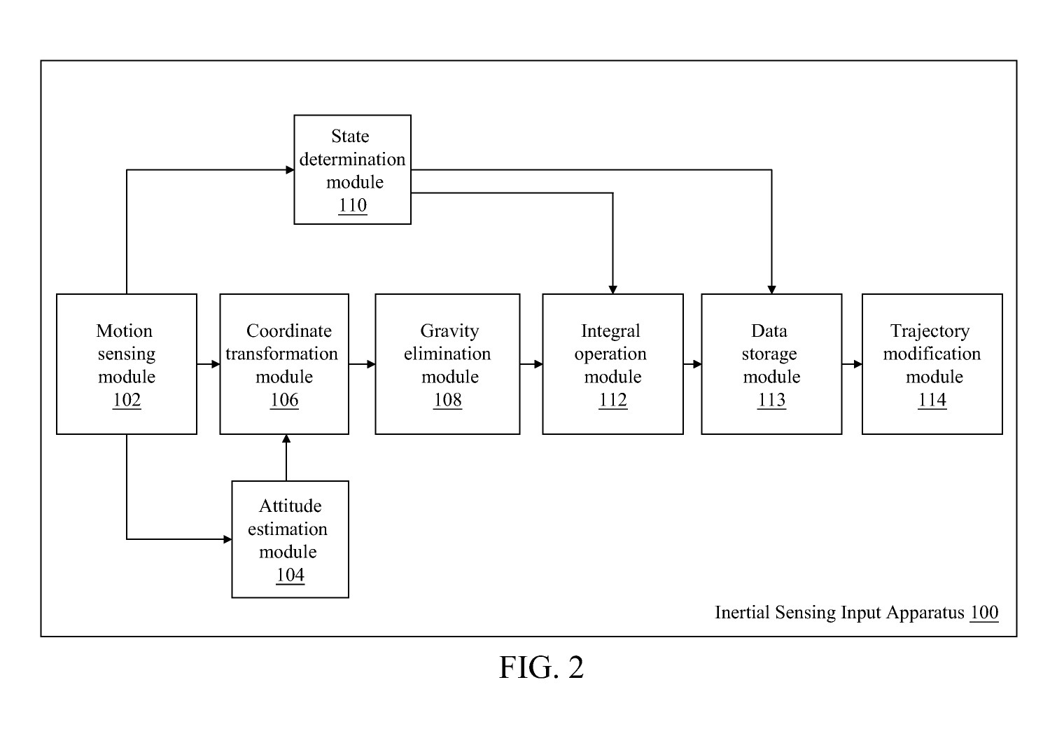

Referring to FIG. 2, FIG. 2 is a structural block diagram of a first embodiment of the inertial sensing input apparatus in FIG. 1. In this embodiment, the inertial sensing input apparatus 100 includes a motion sensing module 102, an attitude estimation module 104, a coordinate transformation module 106, a gravity elimination module 108, a state determination module 110, an integral operation module 112, a data storage module 113 and a trajectory modification module 114. The motion sensing module 102 is coupled to the state determination module 110, the coordinate transformation module 106 and the attitude estimation module 104. The attitude estimation module 104 is coupled to the coordinate transformation module 106. The coordinate transformation module 106 is coupled to the gravity elimination module 108. The gravity elimination module 108 is coupled to the integral operation module 112. The data storage module 113 is coupled to the state determination module 110, the integral operation module 112 and the trajectory modification module 114. The state determination module 110 is coupled to the integral operation module 112.

In this embodiment, the motion sensing module 102 may include an accelerometer, but not limited to the above-mentioned module. The accelerometer is used for measuring relative accelerations a_{x′}, a_{y′} and a_{z′} of the inertial sensing input apparatus 100 in the X′ direction, the Y′ direction and the Z′ direction of the relative coordinate system. This embodiment should not be construed as a limitation to the disclosure thereof, for example, the motion sensing module 102 can also include a gyroscope, a magnetometer or an electronic compass, but not limited to the above-mentioned modules, and it can be adjusted according to actual requirements. The gyroscope is used for measuring angular velocities b_{x′}, b_{y′} and b_{z′} of the inertial sensing input apparatus 100 in the X′ direction, the Y′ direction and the Z′ direction of the relative coordinate system. The magnetometer or the electronic compass is used for measuring magnetic fields c_{x′}, c_{y′} and c_{z′} of the inertial sensing input apparatus 100 in the X′ direction, the Y′ direction and the Z′ direction of the relative coordinate system. The more data (for examples the angular velocities b_{x′}, b_{x′} and b_{z′} and the magnetic fields c_{x′}, c_{y′} and c_{z′}, but not as limitations) of the inertial sensing input apparatus 100 in the X′ direction, the Y′ direction and the Z′ direction of the relative coordinate system is measured by the motion sensing module 102, the more favorable for the computation of moving trajectory of the inertial sensing input apparatus 100.

Referring to FIGS. 1, 2, 3A and 3B, FIGS. 3A and 3B are flowcharts of an inertial sensing input method according to an embodiment of the inertial sensing input apparatus in FIG. 2. The inertial sensing input method includes:

step 202: measuring a motion signal of the inertial sensing input apparatus by the motion sensing module, the motion signal includes a relative acceleration of the inertial sensing input apparatus;

step 204: comparing a variation in the motion signal with a preset value by the state determination module, in order to determine if the inertial sensing input apparatus is in a stationary state or in a moving state, and to detect at least one moving time period of the inertial sensing input apparatus, and a first instant and a second instant in the detected moving time period;

step 206: when the inertial sensing input apparatus is in the moving time period, estimating a rotational attitude of the inertial sensing input apparatus based on the motion signal in the moving time period by the attitude estimation module;

step 208: transforming the relative acceleration in the moving time period to an absolute acceleration based on the rotational attitude in the moving time period by the coordinate transformation module;

step 210: eliminating the gravitation effect from the absolute acceleration in the moving time period by the gravity elimination module;

step 212: calculating a velocity and a displacement of the inertial sensing input apparatus in the moving time period based on the gravity-eliminated absolute acceleration, the first instant and the second instant in the moving time period by the integral operation module;

step 214: storing the first instant, the second instant, the velocity and the displacement of the inertial sensing input apparatus in the moving time period by the data storage module; and

step 216: when the state determination module detects the second instant in the K^{th} moving time period, outputting the K first instants, the K second instants, the K velocities and the K displacements in the K moving time periods to the trajectory modification module by the data storage module, calculating a moving trajectory of the inertial sensing input apparatus in the K moving time periods based on the K first instants, the K second instants, the K velocities and the K displacements by the trajectory modification module, and performing a nonlinear modification onto the moving trajectory, K is a set value and is an integer larger than one or equal to one, and an N^{th} degree equation is used in the nonlinear modification onto the moving trajectory, N is an integer larger than two.

The motion signal Sₘ in the above-mentioned step 202 may include, but not limited to the relative accelerations a_{x′}, a_{y′} and a_{z′}. For example, the motion signal Sₘ may also include the angular velocities b_{x′}, b_{y′} and b_{z′} or the magnetic fields c_{x′}, c_{y′} and c_{z′}, and the motion signal Sₘ may be adjusted according to the setting of the motion sensing module 102.

The stationary state and the moving state in the above-mentioned step 204 are determined by comparing the variation in the motion signal Sₘ in a time sequence with the preset value. For example, an operating state is determined by comparing the variation in the relative acceleration a_{x′} in the time sequence with the preset value THs (a_{x′}). The variation in the relative acceleration a_{x′} in the time sequence may be but not limited to

$$\vert {a}_{{x}^{′}} ( {t}_{i} ) - {a}_{{x}^{′}} ( {t}_{i - 1} ) \vert$$

$$or$$

$$\vert {a}_{{x}^{′}} ( {t}_{i} ) - \frac{{\sum }_{l = 1}^{L} {a}_{{x}^{′}} ( {t}_{i - 1} )}{L} \vert , \\ if i < 1 , \\ {a}_{{x}^{′}} ( {t}_{i - 1} ) = {a}_{{x}^{′}} ( {t}_{0} )$$

where L is a preset positive integer. When |a_{x′}(t₁)−a_{x′}(t₁₋₁)|≦THs(a_{x′}) or

$$\vert {a}_{{x}^{′}} ( {t}_{i} ) - \frac{{\sum }_{l = 1}^{L} {a}_{{x}^{′}} ( {t}_{i - 1} )}{L} \vert \leq THs ( {a}_{{x}^{′}} ) ,$$

then the inertial sensing input apparatus 100 is determined to be in the stationary state by the state determination module 110; when

$$\vert {a}_{{x}^{′}} ( {t}_{i} ) - {a}_{{x}^{′}} ( {t}_{i - 1} ) \vert > THs ( {a}_{{x}^{′}} )$$

$$or$$

$$\vert {a}_{{x}^{′}} ( {t}_{i} ) - \frac{{\sum }_{l = 1}^{L} {a}_{{x}^{′}} ( {t}_{i - 1} )}{L} \vert > THs ( {a}_{{x}^{′}} ) ,$$

then the inertial sensing input apparatus 100 is determined to be in the moving state by the state determination module 110, but the present embodiment is not construed as a limitation to the disclosure thereof. In other words, the operating state can also be determined by comparing the variations in more than one of the parameters of the relative accelerations a_{x′}, a_{y′} and a_{z′}, the angular velocities b_{x′}, b_{y′} and b_{z′} and the magnetic fields c_{x′}, c_{y′} and c_{z′} of the motion signal Sₘ in the time sequence with the corresponding preset values. The more variations in the parameters of the motion signal Sₘ in the time sequence are compared with the corresponding preset values, the higher is the precision of the inertial sensing input apparatus 100 determined to be in the stationary state or the moving state by the state determination module 110.

Furthermore, the moving time period in the above-mentioned step 204 is from the first instant T_{S} when the inertial sensing input apparatus 100 changes from the stationary state to the moving state, to the second instant T_{F} when the inertial sensing input apparatus 100 changes from the moving state to the stationary state. For example, when the inertial sensing input apparatus 100 is in the stationary state before an instant t₀, in the moving state between instants t₀ and t₁, in the stationary state between instants t₁ and t₂, in the moving state between instants t₂ and t₃, in the stationary state between instants t₃ and t₄, then the period between the instants t₀ and t₁ and the period between the instants t₂ and t₃ are the moving time periods of the inertial sensing input apparatus 100. In the present embodiment, a number of the moving time periods may be but not limited to one, in other words, a number of the moving time periods may also be three. Moreover, in the present embodiment, the steps 206 to 214 may be performed when the inertial sensing input apparatus 100 is in the moving time periods, while no step will be performed when the inertial sensing input apparatus 100 is in the stationary (not-moving) time periods.

When the inertial sensing input apparatus 100 is in the moving time period (the operating state of the inertial sensing input apparatus 100 is the moving state), the attitude estimation module 104 calculates the rotational attitude of the inertial sensing input apparatus 100 by using the motion signal Sₘ measured by the motion sensing module 102 (the step 206). When the operating state of the inertial sensing input apparatus 100 is the stationary state, measurements of the relative accelerations a_{x′}, a_{y′} and a_{z′} are the same as the corresponding components of the gravitational acceleration in the X′ direction, the Y′ direction and the Z′ direction in the relative coordinate system.

In the step 208, the relative accelerations a_{x′}, a_{y′} and a_{z′} are transformed to the absolute accelerations aₓ, a_{y} and a_{z} based on the rotation transformation from the relative coordinate system to the absolute coordinate system by the coordinate transformation module 106.

In the step 210, the relative accelerations a_{x′}, a_{y′} and a_{z′} output by the motion sensing module 102 may also be affected by a gravitational acceleration g, thus after the step 208, the absolute accelerations aₓ, a_{y} and a_{z} can be computed by the gravity elimination module 108 to eliminate the effect of the gravitational acceleration g on the absolute accelerations aₓ, a_{y} and a_{z}, but the present embodiment should not be construed as a limitation to the disclosure thereof. In other words, before the step 208 is executed, the relative accelerations a_{x′}, a_{y′} and a_{z′} can be gravity-eliminated by the gravity elimination module 108, then the step 208 is performed in order to output the absolute accelerations aₓ, a_{y} and a_{z} which are not affected by the gravitational acceleration g.

Velocities vₓ, v_{y}, v_{z} and displacements pₓ, p_{y}, p_{z} of the inertial sensing input apparatus 100 are calculated respectively by the integral operation module 112 via a first integral and a double integral of the absolute accelerations aₓ, a_{y} and a_{z} obtained by the gravity elimination module 108, as well as the first instant and the second instant in the moving time period detected by the state determination module 110 (the step 212).

In this embodiment, K may be equal to one, therefore, when P moving time periods are detected by the state determination module 110, P modified moving trajectories are outputs by the inertial sensing input apparatus 100, and P is a positive integer, but this embodiment should not be construed as a limitation to the disclosure thereof. In other words, when K is equal to two and F moving time periods are detected by the state determination module 11, the inertial sensing input apparatus 100 outputs

$$\frac{F}{2}$$

modified moving trajectories, and F is a positive even integer.

Furthermore, the N^{th} degree equation in the step 216 may be but not limited to f(t)=a₀+a₁(t−t₀)+a₂(t−t₀)²+ . . . +a_{N-1}(t−t₀)^{N-1}+a_{N}(t−t₀)_{N}, a₀, a₁, a₂, . . . , a_{N-1} and a_{N} are preset coefficients, t₀ is the first instant of the first moving time period, N is an integer larger than two. For example, if the displacement of the inertial sensing input apparatus 100 calculated by the integral operation module 112 is p=(pₓ, p_{y}, p_{z}), and the displacement of the inertial sensing input apparatus 100 after the moving trajectory is modified by the trajectory modification module 114 is pₘ=(pₘₓ, p_{my}, p_{mz}). Therefore, pₘ(t)−p(t)=f(t). Because f(t)=a₀+a₁(t−t₀)+a₂(t−t₀)²+ . . . +a_{N-1}(t−t₀)^{N-1}+a_{N}(t−t₀)^{N} has to be conformed to a starting condition f(t₀)=pₘ(t₀)−p(t₀)=0 and a finishing condition f(tₙ)=pₘ(tₙ)−p(tₙ)=pₙ−p(tₙ), thus set a₀=0. t₀ is the time of a starting position p₀, that is the first instant of the first moving time period, tₙ is the time of a preset finishing position pₙ, that is the second instant of the K^{th} moving time period.

Furthermore, because a₁, a₂, . . . , a_{N-1} and a_{N} are preset coefficients, thus assume that a₁, a₂, . . . , a_{N-2} and a_{N-1} are equal to 0, and derive that

$${a}_{N} = \frac{{p}_{n} - p ( {t}_{n} )}{{( {t}_{n} - {t}_{0} )}^{N}} , \\ f ( t ) = {{a}_{N} ( t - {t}_{0} )}^{N} = \frac{{p}_{n} - p ( {t}_{n} )}{{( {t}_{n} - {t}_{0} )}^{N}} {( t - {t}_{0} )}^{N} , \\ {p}_{m} ( t ) = p ( t ) + \frac{{p}_{n} - p ( {t}_{ n} )}{{( {t}_{n} - {t}_{0} )}^{N}} {( t - {t}_{0} )}^{N} ,$$

so that pₘ=(pₘₓ, p_{my}, p_{mz}) is calculated, but this example should not be construed as a limitation to the disclosure.

Furthermore, when the second instant of the K^{th} moving time period is detected by the state determination module 110, the inertial sensing input apparatus 100 can be located at a finishing position the same as an starting position p₀ₓ, p_{0y}, p_{0z} or a preset finishing position pₙₓ, p_{ny}, p_{nz} of the inertial sensing input apparatus 100. A preset vector dₓ, d_{y}, d_{z} is the preset finishing position pₙₓ, p_{ny}, p_{nz} relative to the starting position p₀ₓ, p_{0y}, p_{0z}. For examples, when a distance between the preset finishing position pₙₓ and the starting position p₀ₓ is 5 cm, a distance between the preset finishing position p_{ny} and the starting position p_{0y} is 0 cm, a distance between the preset finishing position p_{nz} and the starting position p_{0z} is 0 cm, they indicate that the preset finishing position pₙₓ, p_{ny}, p_{nz} is 5 cm away from the starting position p₀ₓ, p_{0y}, p_{0z} in the X direction.

However, when the digital pen 50 is being used, probably there is virtually no reference objects or measurements, the digital pen 50 disposed with the inertial sensing input apparatus 100 is held by a user, and a position of the starting position p₀ₓ, p_{0y}, p_{0z} or the preset finishing position pₙₓ, p_{ny}, p_{nz} in space is roughly located in vision or imagination by the user. Therefore in a practical operation, when the second instant of the K^{th} moving time period is detected by the state determination module 110, it is possible that there is a deviation between the actual finishing position of the inertial sensing input apparatus 100 and the desired finishing position which is the starting position p₀ₓ, p_{0y}, p_{0z} or the preset finishing position pₙₓ, p_{ny}, p_{nz}. Although the exact finishing position of the inertial sensing input apparatus 100 may not be known, the starting position p₀ₓ, p_{0y}, p_{0z} or the preset finishing position pₙₓ, p_{ny}, p_{nz} is still used for performing the modification onto the moving trajectory mentioned in the step 216. Even though the above-mentioned method will affect the accuracy of the modification of the moving trajectory in the step 216, the divergence of output trajectory caused by double integral in existing techniques can be improved substantially, so that characters input by the digital pen 50 can be recognized with higher precision.

In this embodiment, when the digital pen 50 is started to move from the starting position to perform writing, the steps 202 to 204 are executed. When the inertial sensing input apparatus 100 is in the moving time period, the steps 206 to 214 are executed. When the second instant of the K^{th} moving time period is detected by the state determination module 110, the steps 216 is executed, so that precise trajectories of characters are output by the trajectory modification module 114 based on the velocities vₓ, v_{y}, v_{z} and the displacements pₓ, p_{y}, p_{z} stored in the data storage module 113.

Furthermore, in this embodiment, the steps 206 to 214 can only be performed when the inertial sensing input apparatus 100 is determined by the state determination module 110 to be in the moving time periods. However this embodiment should not be construed as a limitation to the disclosure thereof. For Example, regardless of whether the inertial sensing input apparatus 100 is in the stationary state or the moving state, the steps 206 to 214 may be performed by the attitude estimation module 104, the coordinate transformation module 106, the gravity elimination module 108, the state determination module 110, the integral operation module 112 and the data storage module 113.

Furthermore, in this embodiment, the steps 206 to 212 have to be performed before the second instant of the K^{th} moving time period is detected by the state determination module 110, and K is a set value, but this embodiment should not be construed as a limitation to the disclosure thereof. For example, the steps 206 to 212 can be performed when the second instant of the K^{th} moving time period is detected by the state determination module 110, as detailed in below descriptions.

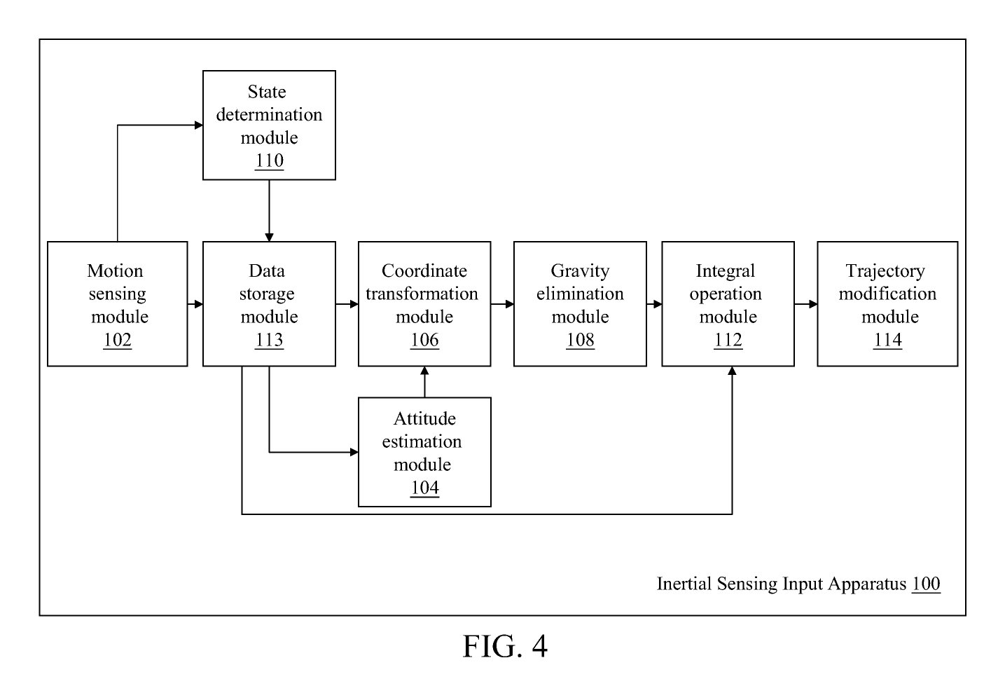

Referring to FIG. 4, it is a structural block diagram of a second embodiment of the inertial sensing input apparatus in FIG. 1. In this embodiment, the inertial sensing input apparatus 100 includes a motion sensing module 102, an attitude estimation module 104, a coordinate transformation module 106, a gravity elimination module 108, a state determination module 110, an integral operation module 112, a data storage module 113 and a trajectory modification module 114. The motion sensing module 102 is coupled to the state determination module 110 and the data storage module 113. The state determination module 110 is coupled to the data storage module 113. The attitude estimation module 104 is coupled to the coordinate transformation module 106 and the data storage module 113. The data storage module 113 is coupled to the coordinate transformation module 106 and the integral operation module 112. The coordinate transformation module 106 is coupled to the gravity elimination module 108. The gravity elimination module 108 is coupled to the integral operation module 112. The integral operation module 112 is coupled to the trajectory modification module 114.

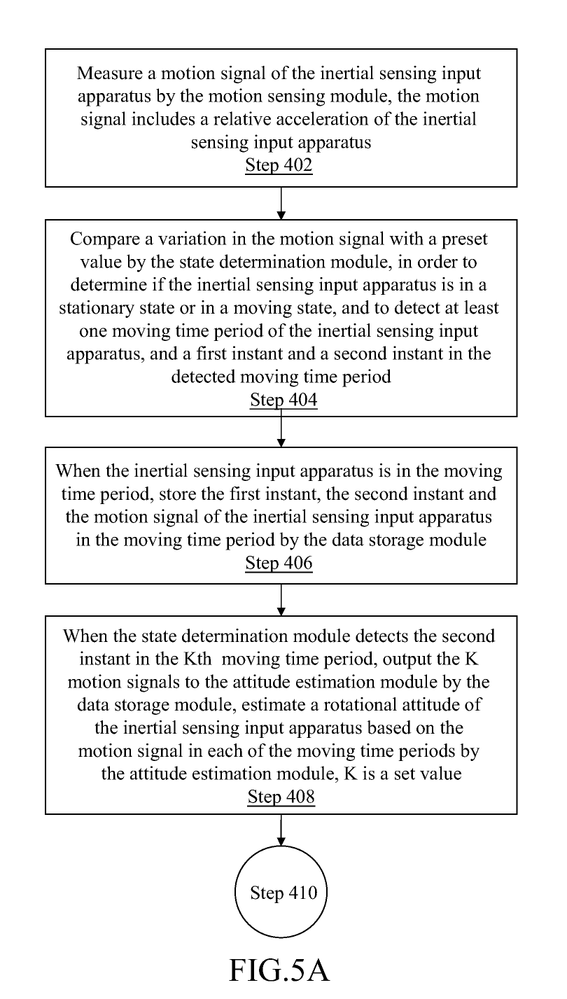

Referring to FIGS. 5A and 5B, FIGS. 5A and 5B are flowcharts of an inertial sensing input method according to an embodiment of the inertial sensing input apparatus in FIG. 4. The inertial sensing input method includes:

step 402: measuring a motion signal of the inertial sensing input apparatus by the motion sensing module, the motion signal includes a relative acceleration of the inertial sensing input apparatus;

step 404: comparing a variation in the motion signal with a preset value by the state determination module, in order to determine if the inertial sensing input apparatus is in a stationary state or in a moving state, and to detect at least one moving time period of the inertial sensing input apparatus, and a first instant and a second instant of the moving time period detected;

step 406: when the inertial sensing input apparatus is in the moving time period, storing the first instant, the second instant and the motion signal of the inertial sensing input apparatus in the moving time period by the data storage module;

step 408: when the state determination module detects the second instant of the K^{th} moving time period, outputting the K motion signals to the attitude estimation module by the data storage module, estimating a rotational attitude of the inertial sensing input apparatus based on the motion signal in each of the moving time periods by the attitude estimation module, K is a set value and is an integer larger than one or equal to one;

step 410: transforming the K relative accelerations to K absolute accelerations based on the K rotational attitudes by the coordinate transformation module;

step 412: eliminating the gravitation effect from the K absolute accelerations by the gravity elimination module;

step 414: calculating a velocity and a displacement of the inertial sensing input apparatus in each of the moving time periods based on the gravity-eliminated K absolute accelerations, the K first instants and the K second instants by the integral operation module; and

step 416: calculating a moving trajectory of the inertial sensing input apparatus in the K moving time periods based on the K velocities and the K displacements by the trajectory modification module, and performing a nonlinear modification onto the moving trajectory, an N^{th} degree equation is used in the nonlinear modification onto the moving trajectory, and N is an integer larger than two.

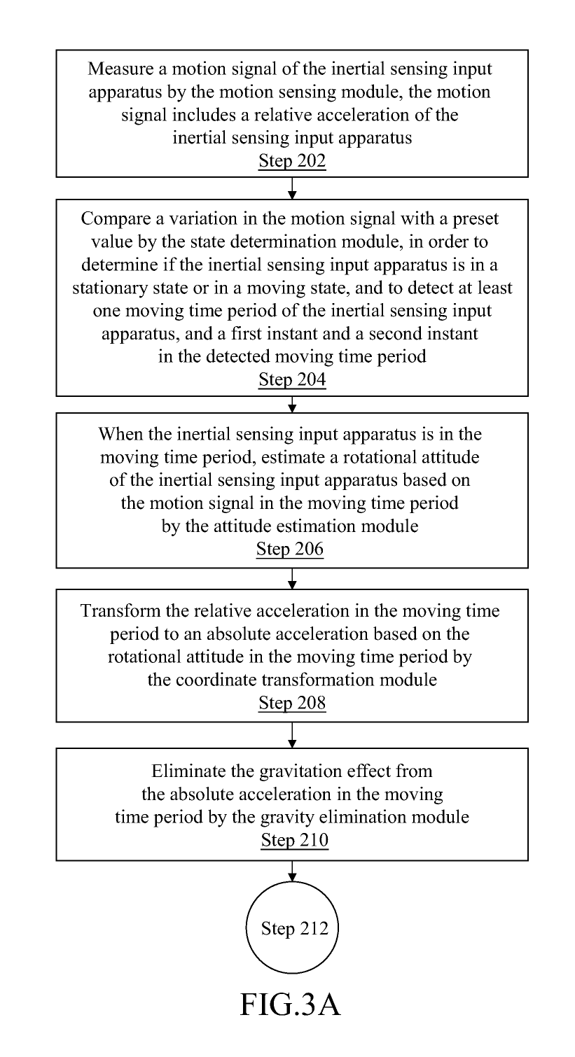

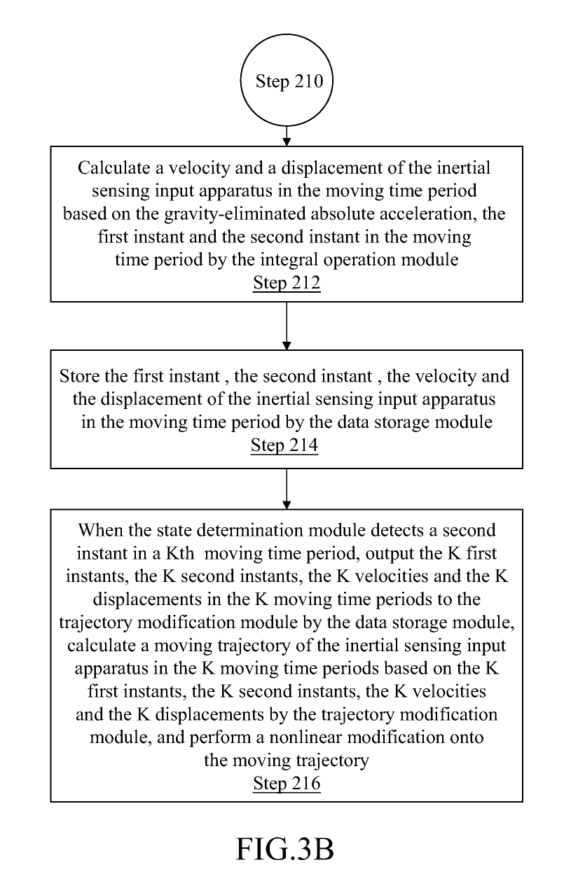

Differences between the inertial sensing input method disclosed in this embodiment and the embodiment in FIG. 3 lie in: when the inertial sensing input apparatus 100 is in the moving time period, only the motion signal Sₘ including the relative accelerations a_{x′}, a_{y′} and a_{z′} measured by the motion sensing module 102, as well as the first instant and the second instant of the moving time period detected by the state determination module 110 are stored in the data storage module 113. When the state determination module 110 detects the second instant of the K^{th} moving time period (the digital pen 50 is done with input of character writing), the step 408 is started by the attitude estimation module 104, the step 410 is started by the coordinate transformation module 106, the step 412 is started by the gravity elimination 108, the step 414 is started by the integral operation module 112. Because the rotational attitude, the absolute acceleration, the velocity and the displacement of the embodiment illustrated in FIG. 3 are output instantaneously in each of the moving time periods, so the rotational attitude, the absolute acceleration, the velocity and the displacement have to be stored in the data storage module 113. Therefore, when the state determination module 110 detects the second instant of the K^{th} moving time period (the digital pen 50 is done with input of character writing), the K first instants, the K second instants, the K velocities and the K displacements stored in the data storage module 113 can be provided to the trajectory modification module 114 for performing the modification onto the moving trajectory.

The above-mentioned inertial sensing input apparatus 100 of the first embodiment and the second embodiment is applicable to the digital pen 50 for writing characters with a finishing point located at the starting position or the preset finishing position of the inertial sensing input apparatus 100, but the finishing points of the characters written by the digital pen 50 are not necessarily located at the starting position or the preset finishing position of the inertial sensing input apparatus 100, therefore another embodiment of the inertial sensing input apparatus 100 is disclosed in the present disclosure that the finishing points of the characters written by the digital pen 50 may be located at the starting position or the preset finishing position of the inertial sensing input apparatus 100.

Furthermore, in this embodiment, the steps 410 to 416 can only be performed when the second instant of the K^{th} moving time period is detected by the state determination module 110, but this embodiment should not be construed as a limitation to the disclosure thereof. For example, when K is an integer larger than two or equal to two, and a second instant of at least one moving time period is detected by the state determination module 110, the steps 410 to 416 can be performed by the attitude estimation module 104, the coordinate transformation module 106, the gravity elimination module 108, the state determination module 110, the integral operation module 112 and the data storage module 113. Furthermore, regardless of whether the inertial sensing input apparatus 100 is in the stationary state or the moving state, the steps 410 to 416 may be performed by the attitude estimation module 104, the coordinate transformation module 106, the gravity elimination module 108, the state determination module 110, the integral operation module 112 and the data storage module 113.

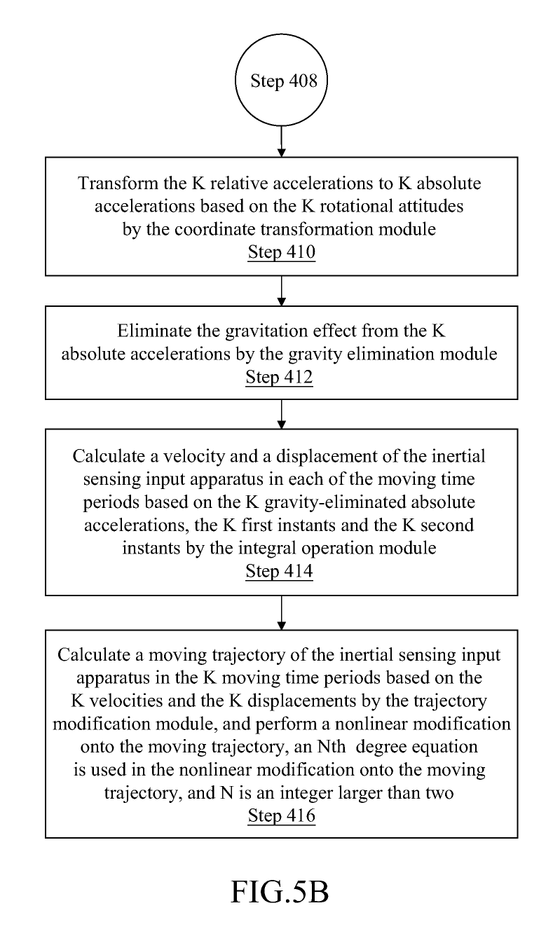

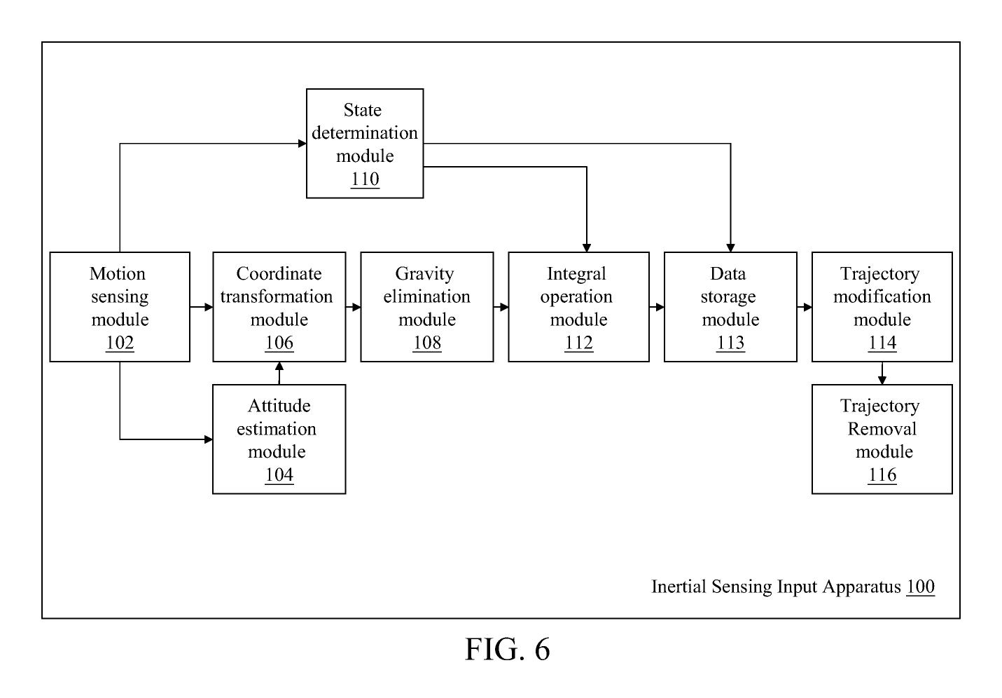

Referring to FIG. 6, FIG. 6 is a structural block diagram of a third embodiment of the inertial sensing input apparatus in FIG. 1. In this embodiment, the inertial sensing input apparatus 100 includes a motion sensing module 102, an attitude estimation module 104, a coordinate transformation module 106, a gravity elimination module 108, a state determination module 110, an integral operation module 112, a data storage module 113, a trajectory modification module 114 and a trajectory removal module 116. The motion sensing module 102 is coupled to the state determination module 110, the attitude estimation module 104 and the coordinate transformation module 106. The attitude estimation module 104 and the coordinate transformation module 106 are coupled to each other. The coordinate transformation module 106 and the gravity elimination module 108 are coupled to each other. The gravity elimination module 108 is coupled to the integral operation module 112. The state determination module 110 is coupled to the data storage module 113 and the integral operation module 112. The trajectory removal module 116 is coupled to the trajectory modification module 114. The data storage module 113 is coupled to the integral operation module 112 and the trajectory modification module 114.

In this embodiment, the motion sensing module 102 may include, but not limited to an accelerometer. The accelerometer is used for measuring the relative accelerations a_{x′}, a_{y′} and a_{z′} of the inertial sensing input apparatus 100 in the X′ direction, the Y′ direction and the Z′ direction of the relative coordinate system. But this embodiment should not be construed as a limitation to the disclosure thereof, for example, the motion sensing module 102 may also include, but not limited to a gyroscope, a magnetometer or an electronic compass, and the motion sensing module 102 may be adjusted according to actual requirements.

Referring to FIGS. 1, 6, 7A and 7B, FIGS. 7A and 7B are flowcharts of an inertial sensing input method according to an embodiment of the inertial sensing input apparatus in FIG. 6. The inertial sensing input method includes:

step 702: measuring a motion signal of the inertial sensing input apparatus by the motion sensing module, the motion signal includes a relative acceleration of the inertial sensing input apparatus;

step 704: comparing a variation in the motion signal with a preset value by the state determination module, in order to determine if the inertial sensing input apparatus is in a stationary state or in a moving state, and to detect at least two moving time periods of the inertial sensing input apparatus, and a first instant and a second instant of each of the detected moving time periods;

step 706: when the inertial sensing input apparatus is in each of the moving time periods, estimating a rotational attitude of the inertial sensing input apparatus based on the motion signal of each of the moving time periods by the attitude estimation module;

step 708: transforming the relative acceleration of each of the moving time periods to an absolute acceleration based on the rotational attitude in each of the moving time periods by the coordinate transformation module;

step 710: eliminating the gravitation effect from the absolute acceleration in each of the moving time periods by the gravity elimination module;

step 712: calculating a velocity and a displacement of the inertial sensing input apparatus in each of the moving time periods based on the gravity-eliminated absolute acceleration, the first instant and the second instant in each of the moving time periods by the integral operation module;

step 714: storing the first instant, the second instant, the velocity and the displacement of the inertial sensing input apparatus in each of the moving time periods by the data storage module;

step 716: when the state determination module detects the second instant of the K^{th} moving time period, outputting the K first instants, the K second instants, the K velocities and the K displacements in the K moving time periods to the trajectory modification module by the data storage module, calculating a moving trajectory of the inertial sensing input apparatus in the K moving time periods based on the K first instants, the K second instants, the K velocities and the K displacements by the trajectory modification module, and performing a modification procedure onto the moving trajectory, and K is a set value and is an integer larger than two or equal to two; and

step 718: removing an auxiliary trajectory of the K^{th} moving time period from the modified moving trajectory by the trajectory removal module in order to produce a primary trajectory.

In this embodiment, a difference between the steps 702 to 714 and the steps 202 to 214 lie in: the number of the moving time periods in this embodiment needs to be larger than two or equal to two.

In this embodiment, K may be equal to 2, therefore, when R moving time periods are detected by the state determination module 110,

$$\frac{R}{2}$$

modified moving trajectories are output by the inertial sensing input apparatus 100. R is a positive even integer, but this embodiment should not be construed as a limitation to the disclosure thereof. In other words, when K is equal to 3 and G moving time periods are detected by the state determination module 11, the inertial sensing input apparatus 100 outputs G/3 modified moving trajectories. G is a positive integer and is a multiple of three.

The modification procedure in the above-mentioned step 716 may be, but not limited to the modification of trajectory in equal proportion using a linear equation, the linear equation can be but not limited to f(t)=a₀+a₁(t−t₀), a₀ and a₁ are preset coefficients, t₀ is the first instant of the first moving time period. For example, if the displacement of the inertial sensing input apparatus 100 calculated by the integral operation module 112 is p=(pₓ, p_{y}, p_{z}), the displacement of the inertial sensing input apparatus 100 after the moving trajectory is modified by the trajectory modification module 114 is pₘ=(pₘₓ, p_{my}, p_{mz}). Therefore, pₘ(t)−p(t)=f(t). Because f(t)=a₀+a₁(t−t₀) has to be conformed to a starting condition f(t₀)=pₘ(t₀)−p(t₀)=0 and a finishing condition f(tₙ)=pₘ(tₙ)−p(tₙ)=pₙ−p(tₙ), thus set a₀=0. t₀ is the time instant at an starting position p₀, that is the first instant of the first moving time period, tₙ is the time instant at a preset finishing position pₙ, that is the second instant of the K^{th} moving time period.

Because a₀=0, and derive that

$${a}_{1} = \frac{{p}_{n} - p ( {t}_{n} )}{{t}_{n} - {t}_{0}} , \\ f ( t ) = {a}_{1} ( t - {t}_{0} ) = \frac{{p}_{n} - p ( {t}_{n} )}{{t}_{n} - {t}_{0}} ( t - {t}_{0} ) , \\ {p}_{m} ( t ) = p ( t ) + \frac{{p}_{n} - p ( {t}_{n} )}{{t}_{n} - {t}_{0}} ( t - {t}_{0} ) ,$$

so that pₘ=(pₘₓ, p_{my}, p_{mz}) is calculated, but this example should not be construed as a limitation to the disclosure.

In other words, the modification procedure in the step 716 can be performed using a nonlinear equation for the trajectory modification, the nonlinear equation can be, but not limited to f(t)=a₀+a₁(t−t₀)+a₂(t−t₀)²+ . . . +a_{N-1}(t−t₀)^{N-1}+a_{N}(t−t₀)^{N}, wherein a₀, a₁, a₂, . . . , a_{N-1} and a_{N} are preset coefficients, N is an integer larger than two or equal to two. For example, if the displacement of the inertial sensing input apparatus 100 calculated by the integral operation module 112 is p=(pₓ, p_{y}, p_{z}), the displacement of the inertial sensing input apparatus 100 after the moving trajectory is modified by the trajectory modification module 114 is pₘ=(pₘₓ, p_{my}, p_{mz}). Therefore, pₘ(t)−p(t)=f(t). Because f(t)=a₀+a₁(t−t₀)+a₂(t−t₀)²+ . . . +a_{N-1}(t−t₀)^{N-1}+a_{N}(t−t₀)^{N} has to be conformed to the starting condition f(t₀)=pₘ(t₀)−p(t₀)=0 and the finishing condition f(tₙ)=pₘ(tₙ)−p(tₙ)=pₙ−p(tₙ), thus set a₀=0. t₀ is the time instant at a starting position p₀, tₙ is the time instant at a preset finishing position pₙ.

Furthermore, because a₁, a₂, . . . , a_{N-1} and a_{N} are preset coefficients, thus assume that a₁, a₂, . . . , a_{N-2} and a_{N-1} are equal to 0, and derive that

$${a}_{N} = \frac{{p}_{n} - p ( {t}_{n} )}{{( {t}_{n} - {t}_{0} )}^{N}} , \\ f ( t ) = {{a}_{N} ( t - {t}_{0} )}^{N} = \frac{{p}_{n} - p ( {t}_{n} )}{{( {t}_{n} - {t}_{0} )}^{N}} {( t - {t}_{0} )}^{N} , \\ {p}_{m} ( t ) = p ( t ) + \frac{{p}_{n} - p ( {t}_{n} )}{{( {t}_{n} - {t}_{0} )}^{N}} {( t - {t}_{0} )}^{N} ,$$

so that pₘ=(pₘₓ, p_{my}, p_{mz}) is calculated, but this example should not be construed as a limitation to the disclosure.

The primary trajectory in the above-mentioned step 718 is the moving trajectory of the inertial sensing input apparatus 100, and the auxiliary trajectory is the moving trajectory from the finishing point of the characters to a specific position. In other words, the first moving time period to a K−1^{th} moving time period is the primary trajectory, while the last moving time period (the K^{th} moving time period) is the auxiliary trajectory.

Every character includes a character starting point and a character finishing point. The character finishing point could be the same point as the character starting point, such as number “0”. The character finishing point and the character starting point could be different, such as number “2”. In this embodiment, the digital pen 50 is started to move from the starting position (the character starting point) to write a character, regardless of the position of the character finishing point, an additional movement from the character finishing point to the starting position or the preset finishing position has to be applied to the inertial sensing input apparatus 100, and a trajectory (auxiliary trajectory) from the character finishing point to the starting position or the preset finishing position is removed by the trajectory removal module 116, in order to obtain a precise trajectory of the character output. Moreover, if the above-mentioned character finishing point is at the same position as the starting position or the preset finishing position, the digital pen 50 has to be moved again away from the character finishing point and instantly back to the starting position or the preset finishing position.

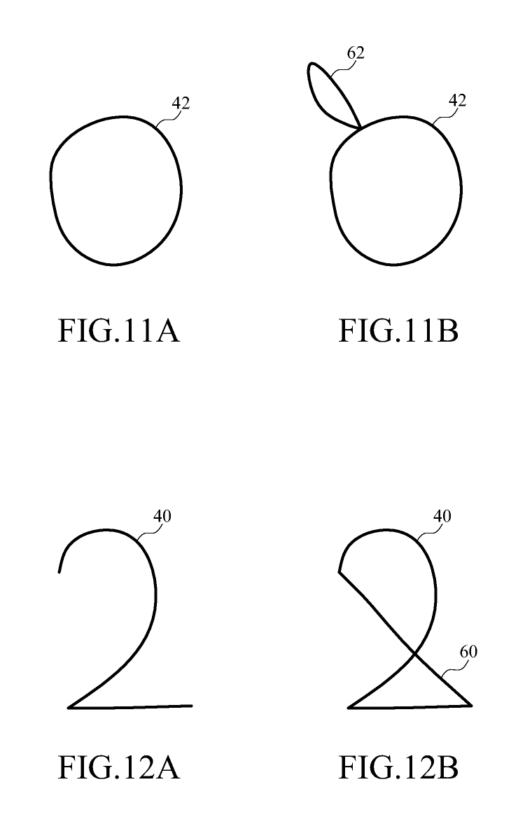

FIG. 11A is a schematic diagram of a primary trajectory of number “0” and FIG. 11B is a schematic diagram of a primary trajectory and an auxiliary trajectory of number “0”. As shown in FIG. 11A and FIG. 11B, for example, K is a positive integer 2 and a primary trajectory 42 of a number “0” is a moving trajectory in a first moving time period. Because the character finishing point of the number “0” is at the same position as the starting position of the number “0”, a digital pen 50 has to be moved again away form the character finishing point and back to the starting position. (That is, an auxiliary trajectory 62 of the number “0” is a moving trajectory in a second moving time period) Then the writing of the number “0” using the digital pen 50 is completed.

Furthermore, FIG. 12A is a schematic diagram of a primary trajectory of number “2” and FIG. 12B is a schematic diagram of a primary trajectory and an auxiliary trajectory of number “2.” As shown in FIG. 12A and FIG. 12B, for example, K is a positive integer 2 and a primary trajectory 40 of a number “2” is a moving trajectory in a first moving time period. Because the character finishing point of the number “2” is not at the same position as the starting position or the preset finishing position of the number “2”, a digital pen 50 only has to be moved form the character finishing point to the starting position or the preset finishing position of the number “2” and the writing of the number “2” is completed. In other words, the primary trajectory 40 of the number “2” is the moving trajectory of the digital pen 50 in the first moving time period, the auxiliary trajectory 60 of the number “2” is the moving trajectory of the digital pen 50 in a second moving time period. Then the writing of the number “2” using the digital pen 50 is completed

However, when the digital pen 50 is being used, probably there is virtually no reference objects or measurements, the digital pen 50 disposed with the inertial sensing input apparatus 100 is held by a user, and a position of the starting position or the preset finishing position in space is roughly positioned based on the user's vision or imagination. Therefore in a practical operation, when the second instant of the K^{th} moving time period is detected by the state determination module 110, it is possible that there is a deviation between the actual finishing position of the inertial sensing input apparatus 100 and the desired finishing position which is the same as the starting position or the preset finishing position. Although the exact finishing position of the inertial sensing input apparatus 100 may not be known, the starting position or the preset finishing position is still used for performing the modification onto the moving trajectory mentioned in the step 716. Even though the above-mentioned method will affect an accuracy of the modification of the moving trajectory in the step 716, the divergence of the output trajectory caused by double integral in existing techniques can be improved substantially so that the character input by the digital pen 50 may be recognized with higher precision.

Furthermore, in this embodiment, the steps 706 to 714 may only be performed when the inertial sensing input apparatus 100 is determined by the state determination module 110 to be in the moving time periods, but this embodiment should not be construed as a limitation to the disclosure thereof. For Example, regardless of whether the inertial sensing input apparatus 100 is in the stationary state or the moving state, the steps 706 to 714 may be performed by the attitude estimation module 104, the coordinate transformation module 106, the gravity elimination module 108, the state determination module 110, the integral operation module 112 and the data storage module 113.

Moreover, in this embodiment, the steps 706 to 712 have to be performed before the second instant of the K^{th} moving time period is detected by the state determination module 110, but this embodiment should not be construed as a limitation to the disclosure thereof. For example, the steps 706 to 712 may be performed when the second instant of the K^{th} moving time period is detected by the state determination module 110, as detailed in below descriptions.

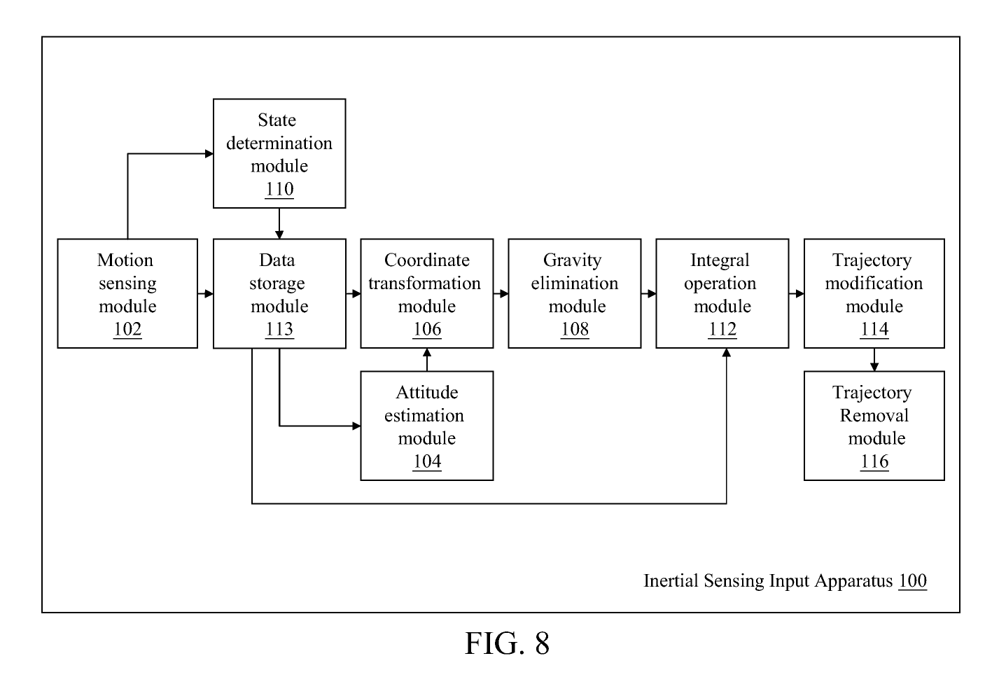

Referring to FIG. 8, FIG. 8 is a structural block diagram of a fourth embodiment of the inertial sensing input apparatus in FIG. 1. In this embodiment, the inertial sensing input apparatus 100 includes a motion sensing module 102, an attitude estimation module 104, a coordinate transformation module 106, a gravity elimination module 108, a state determination module 110, an integral operation module 112, a data storage module 113, a trajectory modification module 114 and a trajectory removal module 116. The motion sensing module 102 is coupled to the state determination module 110 and the data storage module 113. The state determination module 110 is coupled to the data storage module 113. The attitude estimation module 104 is coupled to the coordinate transformation module 106 and the data storage module 113. The data storage module 113 is coupled to the coordinate transformation module 106 and the integral operation module 112. The coordinate transformation module 106 is coupled to the gravity elimination module 108. The gravity elimination module 108 is coupled to the integral operation module 112. The integral operation module 112 is coupled to the trajectory modification module 114. The trajectory modification module 114 is coupled to the trajectory removal module 116.

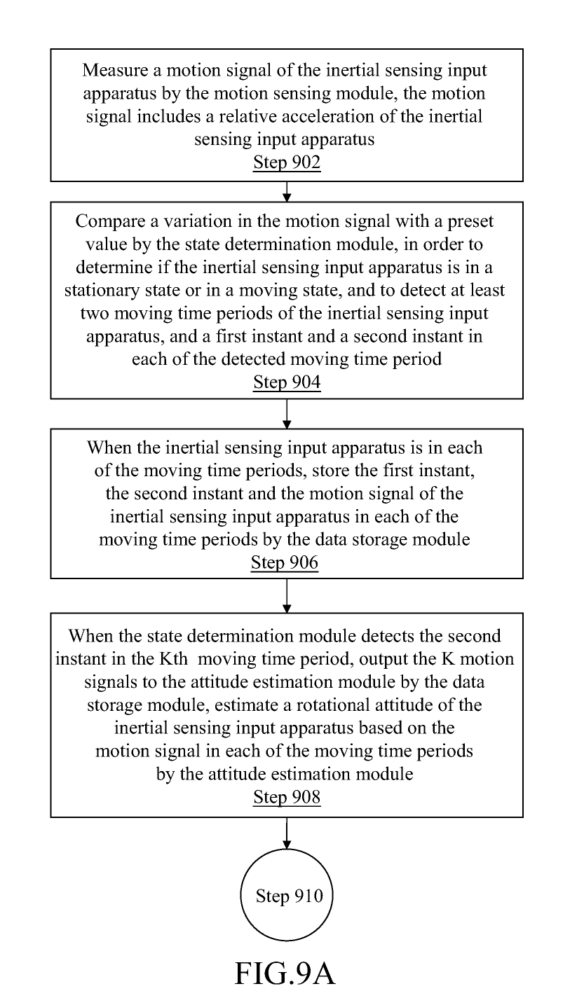

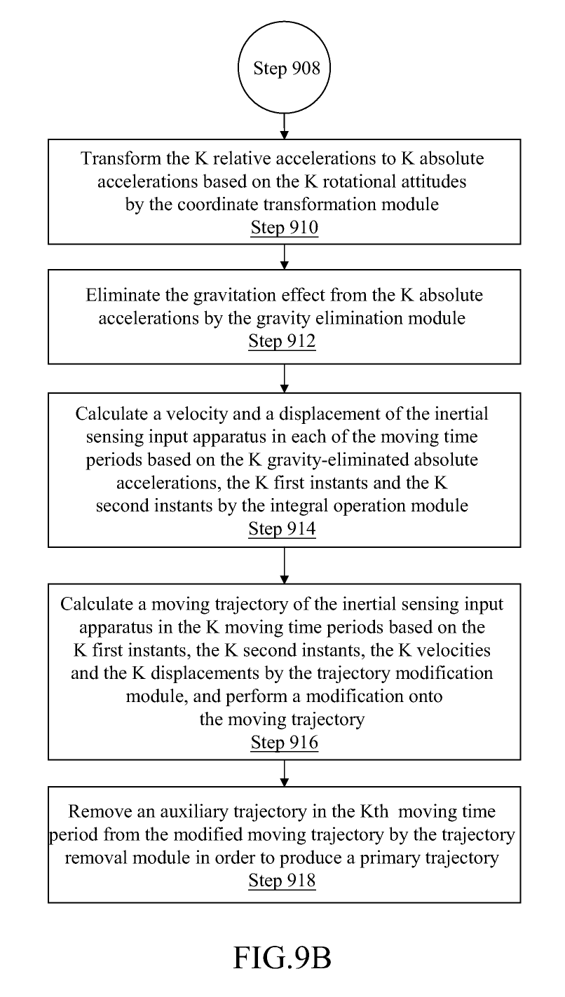

Referring to FIGS. 9A and 9B, FIGS. 9A and 9B are flowcharts of an inertial sensing input method according to an embodiment of the inertial sensing input apparatus in FIG. 8. The inertial sensing input method includes:

step 902: measuring a motion signal of the inertial sensing input apparatus by the motion sensing module, the motion signal includes a relative acceleration of the inertial sensing input apparatus;

step 904: comparing a variation in the motion signal with a preset value by the state determination module, in order to determine if the inertial sensing input apparatus is in a stationary state or in a moving state, and to detect at least two moving time periods of the inertial sensing input apparatus, and a first instant and a second instant of each of the detected moving time periods;

step 906: when the inertial sensing input apparatus is in each of the moving time periods, storing the first instant, the second instant and the motion signal of the inertial sensing input apparatus in each of the moving time periods by the data storage module;

step 908: when the state determination module detects the second instant of the K^{th} moving time period, outputting the K motion signals to the attitude estimation module by the data storage module, estimating a rotational attitude of the inertial sensing input apparatus based on the motion signal in each of the moving time periods by the attitude estimation module;

step 910: transforming the K relative accelerations to K absolute accelerations based on the K rotational attitudes by the coordinate transformation module;

step 912: eliminating the gravitation effect from the K absolute accelerations by the gravity elimination module;

step 914: calculating a velocity and a displacement of the inertial sensing input apparatus in each of the moving time periods based on the gravity-eliminated K absolute accelerations, the K first instants and the K second instants by the integral operation module;

step 916: calculating a moving trajectory of the inertial sensing input apparatus in the K moving time periods based on the K first instants, the K second instants, the K velocities and the K displacements by the trajectory modification module, and performing a modification procedure onto the moving trajectory; and

step 918: removing an auxiliary trajectory of the K^{th} moving time period from the modified moving trajectory by the trajectory removal module in order to produce a primary trajectory.

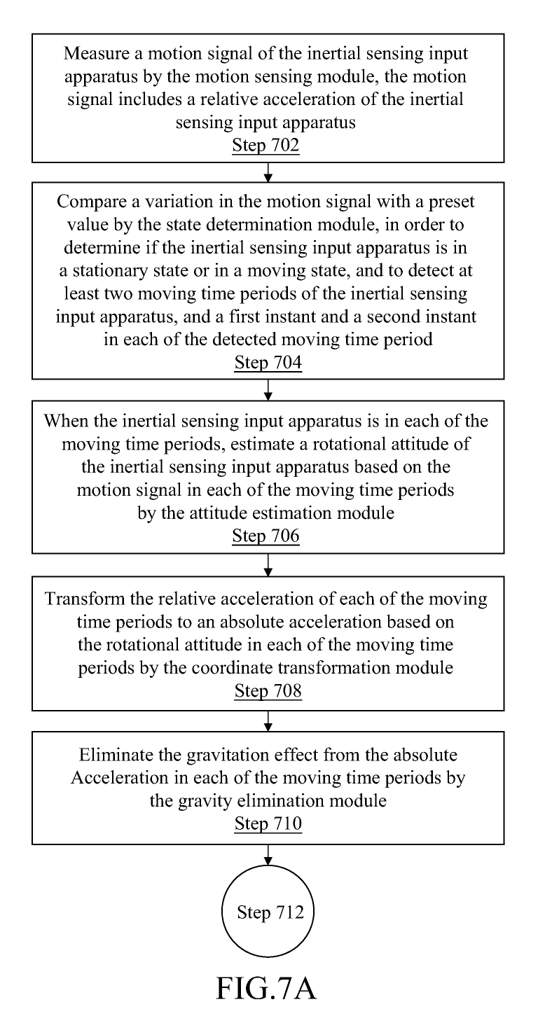

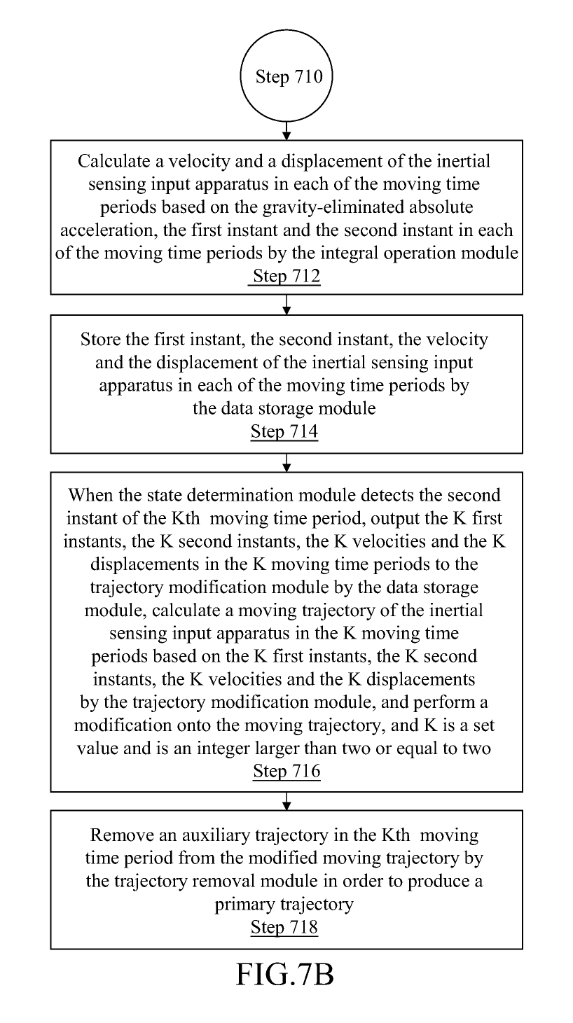

Differences between the inertial sensing input method disclosed in this embodiment and the embodiment in FIG. 7 lie in: when the inertial sensing input apparatus 100 is in each of the moving time periods, only the motion signal Sₘ including the relative accelerations a_{x′}, a_{y′} and a_{z′} measured by the motion sensing module 102, as well as the first instant and the second instant of each of the moving time periods detected by the state determination module 110 are stored in the data storage module 113. When the state determination module 110 detects the second instant of the K^{th} moving time period, the step 708 is started by the attitude estimation module 104, the step 710 is started by the coordinate transformation module 106, the step 712 is started by the gravity elimination 108, the step 714 is started by the integral operation module 112. The rotational attitude, the absolute acceleration, the velocity and the displacement of the embodiment illustrated in FIG. 7 are output instantaneously in each of the moving time periods, therefore the rotational attitude, the absolute acceleration, the velocity and the displacement have to be stored in the data storage module 113, so that when the state determination module 110 detects the second instant of the K^{th} moving time period (the digital pen 50 is done with input of character writing), the K first instants, the K second instants, the K velocities and the K displacements stored in the data storage module 113 may be provided to the trajectory modification module 114 for performing modification onto the moving trajectory.

The design of the auxiliary trajectory is used in the above-mentioned third embodiment and the fourth embodiment, so the finishing points of the character written by the digital pen 50 can be located at the starting position or the preset finishing position of the inertial sensing input apparatus 100, but the third embodiment and the fourth embodiment should not be construed as limitations to the disclosure thereof.

Furthermore, in this embodiment, the steps 910 to 918 may only be performed when the second instant of the K^{th} moving time period is detected by the state determination module 110, but this embodiment should not be construed as a limitation to the disclosure thereof. For example, when a second instant of at least one moving time period is detected by the state determination module 110, the steps 910 to 918 may be performed by the attitude estimation module 104, the coordinate transformation module 106, the gravity elimination module 108, the state determination module 110, the integral operation module 112 and the data storage module 113. Furthermore, regardless of whether the inertial sensing input apparatus 100 is in the stationary state or the moving state, the steps 910 to 918 may be performed by the attitude estimation module 104, the coordinate transformation module 106, the gravity elimination module 108, the state determination module 110, the integral operation module 112 and the data storage module 113.

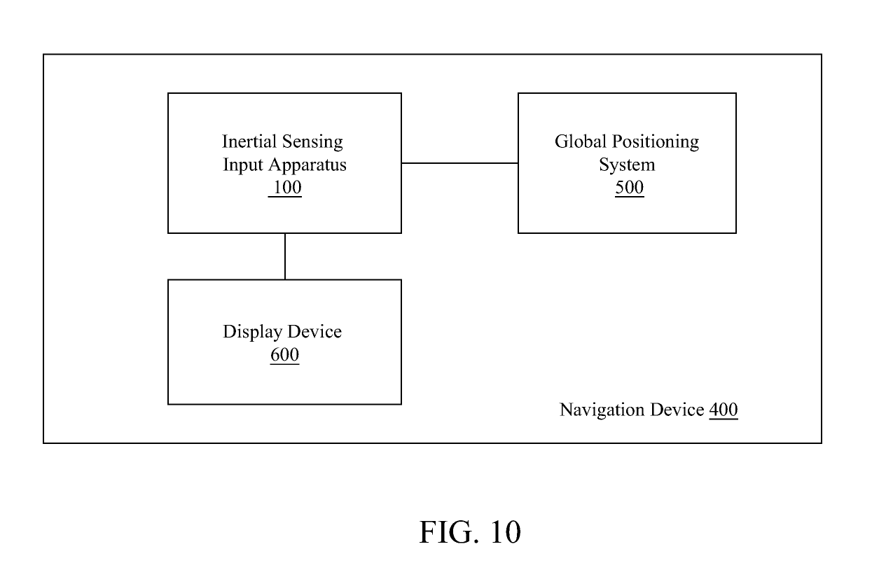

The above-mentioned embodiments are embodiments of the inertial sensing input apparatus 100 being applied in the digital pen 50, but the above-mentioned embodiments should not be construed as limitations to the application fields of the inertial sensing input apparatus 100. In other words, the inertial sensing input apparatus 100 may also be applied in navigation devices or vehicle driving data recorders. Referring to FIG. 10 for example, FIG. 10 is a structural block diagram of an embodiment of an inertial sensing input apparatus disclosed in the present disclosure being applied in a navigation device. In this embodiment, a navigation device 400 includes a global positioning system (GPS) 500, the inertial sensing input apparatus 100 and a display device 600. The global positioning system 500 is used for locating the position of the navigation device 400, while the inertial sensing input apparatus 100 is used for establishing moving trajectories of the navigation device 400. When a satellite signal (that is, a GPS signal) received by the global positioning system 500 is disappeared, and the position of the navigation device 400 may not be obtained, the position where the satellite signal is disappeared (the starting position of the above-mentioned embodiments) and the position where the satellite signal is restored (the specific position of the above-mentioned embodiments) may be used by the inertial sensing input apparatus 100 to perform a modification procedure onto a trajectory, in order to obtain a precise moving trajectory of the navigation device 400. And the moving trajectory of the navigation device 400 may be displayed by the display device 600.

According to an inertial sensing input apparatus and method thereof disclosed in the present disclosure, by the setting of the inertial sensing input apparatus at the starting position or the preset finishing position in the second instant of the K^{th} moving time period, to modify the moving trajectory by the trajectory modification module, in order to produce a moving trajectory with higher precision. By the setting of the trajectory removal module, redundant auxiliary trajectories may be separated and removed in order to produce a primary trajectory with higher precision.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. An inertial sensing input apparatus, comprising:
a motion sensing module measuring a motion signal of the inertial sensing input apparatus, the motion signal including a relative acceleration of the inertial sensing input apparatus;
a state determination module comparing a variation in the motion signal with a preset value, in order to determine if the inertial sensing input apparatus is in a stationary state or in a moving state, and to detect at least one moving time period of the inertial sensing input apparatus, and a first instant and a second instant in the detected moving time period, wherein the moving time period is from the first instant when the inertial sensing input apparatus changes from the stationary state to the moving state to the second instant when the inertial sensing input apparatus changes from the moving state to the stationary state;
an attitude estimation module estimating a rotational attitude of the inertial sensing input apparatus based on the motion signal of the inertial sensing input apparatus in the moving time period;
a coordinate transformation module transforming the relative acceleration in the moving time period to an absolute acceleration based on the rotational attitude in the moving time period;
a gravity elimination module eliminating the gravitation effect from the absolute acceleration in the moving time period;
an integral operation module calculating a velocity and a displacement of the inertial sensing input apparatus in the moving time period based on the gravity-eliminated absolute acceleration, the first instant and the second instant in the moving time period;
a data storage module storing the first instant, the second instant, the velocity and the displacement of the inertial sensing input apparatus in the moving time period; and
a trajectory modification module, when the second instant in the K^{th} moving time period is detected by the state determination module, the data storage module outputs the K first instants, the K second instants, the K velocities and the K displacements in the K moving time periods to the trajectory modification module, the trajectory modification module calculates a moving trajectory of the inertial sensing input apparatus in the K moving time periods based on the K first instants, the K second instants, the K velocities and the K displacements, and performs a nonlinear modification, wherein K is a set value and K is an integer larger than one or equal to one, and an N^{th} degree equation is used in the nonlinear modification onto the moving trajectory, N is an integer larger than two.

2. The inertial sensing input apparatus as claimed in claim 1, wherein the motion signal further includes an angular velocity of the inertial sensing input apparatus.

3. The inertial sensing input apparatus as claimed in claim 1, wherein the motion signal further includes a magnetic field of the inertial sensing input apparatus.

4. The inertial sensing input apparatus as claimed in claim 1, wherein when the second instant in the K^{th} moving time period is detected by the state determination module, the inertial sensing input apparatus is located at a finishing position near or the same as a starting position or a preset finishing position other than the starting position.

5. An inertial sensing input method, comprising:
measuring a motion signal of an inertial sensing input apparatus by a motion sensing module, the motion signal including a relative acceleration of the inertial sensing input apparatus;
comparing a variation in the motion signal with a preset value by a state determination module, in order to determine if the inertial sensing input apparatus is in a stationary state or in a moving state, and to detect at least one moving time period of the inertial sensing input apparatus, and a first instant and a second instant in the detected moving time period, wherein the moving time period is from the first instant when the inertial sensing input apparatus changes from the stationary state to the moving state, to the second instant when the inertial sensing input apparatus changes from the moving state to the stationary state;
estimating a rotational attitude of the inertial sensing input apparatus based on the motion signal of the inertial sensing input apparatus in the moving time period by an attitude estimation module;
transforming the relative acceleration in the moving time period to an absolute acceleration based on the rotational attitude in the moving time period by a coordinate transformation module;
Eliminating the gravitation effect from the absolute acceleration in the moving time period by a gravity elimination module;
calculating a velocity and a displacement of the inertial sensing input apparatus in the moving time period based on the gravity-eliminated absolute acceleration, the first instant and the second instant in the moving time period by an integral operation module;
storing the first instant, the second instant, the velocity and the displacement of the inertial sensing input apparatus in the moving time period by a data storage module; and
when the second instant in the K^{th} moving time period being detected by the state determination module, outputting the K first instants, the K second instants, the K velocities and the K displacements in the K moving time periods to a trajectory modification module by the data storage module, calculating a moving trajectory of the inertial sensing input apparatus in the K moving time periods based on the K first instants, the K second instants, the K velocities and the K displacements by the trajectory modification module, and performing a nonlinear modification, wherein K is a set value and K is an integer larger than one or equal to one, an N^{th} degree equation is used in the nonlinear modification onto the moving trajectory, N is an integer larger than two.

6. An inertial sensing input apparatus, comprising:
a motion sensing module measuring a motion signal of the inertial sensing input apparatus, the motion signal including a relative acceleration of the inertial sensing input apparatus;
a state determination module comparing a variation in the motion signal with a preset value, in order to determine if the inertial sensing input apparatus being in a stationary state or in a moving state, and to detect at least two moving time periods of the inertial sensing input apparatus, and a first instant and a second instant in each of the detected moving time periods, wherein each of the moving time periods is from the first instant when the inertial sensing input apparatus changes from the stationary state to the moving state to the second instant when the inertial sensing input apparatus changes from the moving state to the stationary state;
an attitude estimation module estimating a rotational attitude of the inertial sensing input apparatus based on the motion signal of the inertial sensing input apparatus in each of the moving time periods;
a coordinate transformation module transforming the relative acceleration in each of the moving time periods to an absolute acceleration based on the rotational attitude in each of the moving time periods;
a gravity elimination module eliminating the gravitation effect from the absolute acceleration in each of the moving time periods;
an integral operation module calculating a velocity and a displacement of the inertial sensing input apparatus in each of the moving time periods based on the gravity-eliminated absolute acceleration, the first instant and the second instant in each of the moving time periods;
a data storage module storing the first instant, the second instant, the velocity and the displacement of the inertial sensing input apparatus in each of the moving time periods;
a trajectory modification module, when the second instant in the K^{th} moving time period is detected by the state determination module, the data storage module outputs the K first instants, the K second instants, the K velocities and the K displacements in the K moving time periods to the trajectory modification module, the trajectory modification module calculates a moving trajectory of the inertial sensing input apparatus in the K moving time periods based on the K first instants, the K second instants, the K velocities and the K displacements, and performs a modification onto the moving trajectory, wherein K is a set value and is an integer larger than two or equal to two; and
a trajectory removal module removing an auxiliary trajectory in the K^{th} moving time period from the modified moving trajectory in order to produce a primary trajectory.

7. The inertial sensing input apparatus as claimed in claim 6, wherein the motion signal further includes an angular velocity of the inertial sensing input apparatus.

8. The inertial sensing input apparatus as claimed in claim 6, wherein the motion signal further includes a magnetic field of the inertial sensing input apparatus.

9. The inertial sensing input apparatus as claimed in claim 6, wherein the trajectory modification module performs a linear modification onto the moving trajectory.

10. The inertial sensing input apparatus as claimed in claim 6, wherein the trajectory modification module performs a nonlinear modification onto the moving trajectory.

11. The inertial sensing input apparatus as claimed in claim 6, wherein when the second instant in the K^{th} moving time period is detected by the state determination module, the inertial sensing input apparatus is located at a finishing position near or the same as a starting position or a preset finishing position other than the starting position.

12. An inertial sensing input method, comprising:
measuring a motion signal of an inertial sensing input apparatus by a motion sensing module, the motion signal including a relative acceleration of the inertial sensing input apparatus;
comparing a variation in the motion signal with a preset value by a state determination module, in order to determine if the inertial sensing input apparatus is in a stationary state or in a moving state, and to detect at least two moving time periods of the inertial sensing input apparatus, and a first instant and a second instant in each of the detected moving time periods, wherein each of the moving time periods is from the first instant when the inertial sensing input apparatus changes from the stationary state to the moving state, to the second instant when the inertial sensing input apparatus changes from the moving state to the stationary state;
estimating a rotational attitude of the inertial sensing input apparatus based on the motion signal of the inertial sensing input apparatus in each of the moving time periods by an attitude estimation module;
transforming the relative acceleration in each of the moving time periods to an absolute acceleration based on the rotational attitude in each of the moving time periods by a coordinate transformation module;
eliminating the gravitation effect from the absolute acceleration in each of the moving time periods by a gravity elimination module;
calculating a velocity and a displacement of the inertial sensing input apparatus in each of the moving time periods based on the gravity-eliminated absolute acceleration, the first instant and the second instant of each of the moving time periods by an integral operation module;
storing the first instant, the second instant, the velocity and the displacement of the inertial sensing input apparatus in each of the moving time periods by a data storage module;
when the second instant in the K^{th} moving time period being detected by the state determination module, outputting the K first instants, the K second instants, the K velocities and the K displacements in the K moving time periods to a trajectory modification module by the data storage module, calculating a moving trajectory of the inertial sensing input apparatus in the K moving time periods based on the K first instants, the K second instants, the K velocities and the K displacements by the trajectory modification module, and performing a modification onto the moving trajectory, wherein K is a set value and is an integer larger than two or equal to two, and
removing an auxiliary trajectory in the K^{th} moving time period from the modified moving trajectory by a trajectory removal module in order to produce a primary trajectory.

13. An inertial sensing input apparatus, comprising:
a motion sensing module measuring a motion signal of the inertial sensing input apparatus, the motion signal including a relative acceleration of the inertial sensing input apparatus;
a state determination module comparing a variation in the motion signal with a preset value, in order to determine if the inertial sensing input apparatus is in a stationary state or in a moving state, and to detect at least one moving time period of the inertial sensing input apparatus, and a first instant and a second instant in the detected moving time period, wherein the moving time period is from the first instant when the inertial sensing input apparatus changes from the stationary state to the moving state to the second instant when the inertial sensing input apparatus changes from the moving state to the stationary state;
a data storage module storing the first instant, the second instant and the motion signal of the inertial sensing input apparatus in the moving time period;
an attitude estimation module, when the second instant of the K^{th} moving time period is detected by the state determination module, the data storage module outputs the K first instants, the K second instants and the K motion signals to the attitude estimation module, the attitude estimation module estimates a rotational attitude of the inertial sensing input apparatus based on the motion signal in each of the moving time periods, wherein K is a set value and K is an integer larger than one or equal to one;
a coordinate transformation module transforming the K relative accelerations to K absolute accelerations based on the K rotational attitudes;
a gravity elimination module eliminating the gravitation effect from the K absolute accelerations;
an integral operation module calculating a velocity and a displacement of the inertial sensing input apparatus in each of the moving time periods based on the gravity-eliminated K absolute accelerations, the K first instants and the K second instants; and
a trajectory modification module calculating a moving trajectory of the inertial sensing input apparatus in the K moving time periods based on the K first instants, the K second instants, the K velocities and the K displacements, and performing a nonlinear modification, wherein an N^{th} degree equation is used in the nonlinear modification onto the moving trajectory, N is an integer larger than two.

14. The inertial sensing input apparatus as claimed in claim 13, wherein the motion signal further includes an angular velocity of the inertial sensing input apparatus.

15. The inertial sensing input apparatus as claimed in claim 13, wherein the motion signal further includes a magnetic field of the inertial sensing input apparatus.

16. The inertial sensing input apparatus as claimed in claim 13, wherein when the second instant of the K^{th} moving time period is detected by the state determination module, the inertial sensing input apparatus is located at a finishing position near or the same as a starting position or a preset finishing position other than the starting position.

17. An inertial sensing input method, comprising:
measuring a motion signal of an inertial sensing input apparatus by a motion sensing module, the motion signal including a relative acceleration of the inertial sensing input apparatus;
comparing a variation in the motion signal with a preset value by a state determination module, in order to determine if the inertial sensing input apparatus is in a stationary state or in a moving state, and to detect at least one moving time period of the inertial sensing input apparatus, and a first instant and a second instant in the detected moving time period, wherein the moving time period is from the first instant when the inertial sensing input apparatus changes from the stationary state to the moving state, to the second instant when the inertial sensing input apparatus changes from the moving state to the stationary state;
storing the first instant, the second instant and the motion signal of the inertial sensing input apparatus in the moving time period by a data storage module;
when the second instant of the K^{th} moving time period being detected by the state determination module, outputting the K motion signals to an attitude estimation module by the data storage module, estimating a rotational attitude of the inertial sensing input apparatus based on the motion signal in each of the moving time periods by the attitude estimation module, wherein K is a set value and K is an integer larger than one or equal to one;
transforming the K relative accelerations to K absolute accelerations based on the K rotational attitudes by a coordinate transformation module;
eliminating the gravitation effect from the K absolute accelerations by a gravity elimination module;
calculating a velocity and a displacement of the inertial sensing input apparatus in each of the moving time periods based on the K gravity-eliminated absolute accelerations, the K first instants and the K second instants by an integral operation module; and
calculating a moving trajectory of the inertial sensing input apparatus in the K moving time periods based on the K first instants, the K second instants, the K velocities and the K displacements by a trajectory modification module, and performing a nonlinear modification, wherein an N^{th} degree equation is used in the nonlinear modification onto the moving trajectory, N is an integer larger than two.

18. An inertial sensing input apparatus, comprising:
a motion sensing module measuring a motion signal of the inertial sensing input apparatus, the motion signal including a relative acceleration of the inertial sensing input apparatus;
a state determination module comparing a variation in the motion signal with a preset value, in order to determine if the inertial sensing input apparatus is in a stationary state or in a moving state, and to detect at least two moving time periods of the inertial sensing input apparatus, and a first instant and a second instant in each of the moving time periods detected, wherein each of the moving time periods is from the first instant when the inertial sensing input apparatus changes from the stationary state to the moving state to the second instant when the inertial sensing input apparatus changes from the moving state to the stationary state;
a data storage module storing the first instant, the second instant and the motion signal of the inertial sensing input apparatus in each of the moving time periods;
an attitude estimation module, when the second instant of the K^{th} moving time period is detected by the state determination module, the data storage module outputs the K motion signals to the attitude estimation module, the attitude estimation module estimates K rotational attitudes of the inertial sensing input apparatus based on the K motion signals in the K moving time periods, wherein K is a set value and is an integer larger than two or equal to two;
a coordinate transformation module transforming the K relative accelerations to K absolute accelerations based on the K rotational attitudes;
a gravity elimination module eliminating the gravitation effect from the K absolute accelerations;
an integral operation module calculating a velocity and a displacement of the inertial sensing input apparatus in each of the moving time periods based on the K gravity-eliminated absolute accelerations, the K first instants and the K second instants;
a trajectory modification module calculating a moving trajectory of the inertial sensing input apparatus in the K moving time periods based on the K first instants, the K second instants, the K velocities and the K displacements, and performing a modification procedure onto the moving trajectory; and
a trajectory removal module removing an auxiliary trajectory in the K^{th} moving time period from the modified moving trajectory in order to produce a primary trajectory.

19. The inertial sensing input apparatus as claimed in claim 18, wherein the motion signal further includes an angular velocity of the inertial sensing input apparatus.

20. The inertial sensing input apparatus as claimed in claim 18, wherein the motion signal further includes a magnetic field of the inertial sensing input apparatus.

21. The inertial sensing input apparatus as claimed in claim 18, wherein the trajectory modification module performs a linear modification of the moving trajectory.

22. The inertial sensing input apparatus as claimed in claim 18, wherein the trajectory modification module performs a nonlinear modification of the moving trajectory.

23. The inertial sensing input apparatus as claimed in claim 18, wherein when the second instant in the K^{th} moving time period is detected by the state determination module, the inertial sensing input apparatus is located at a finishing position near or the same as a starting position or a preset finishing position other than the starting position.

24. An inertial sensing input method, comprising:
measuring a motion signal of an inertial sensing input apparatus by a motion sensing module, the motion signal including a relative acceleration of the inertial sensing input apparatus;
comparing a variation in the motion signal with a preset value by a state determination module, in order to determine if the inertial sensing input apparatus is in a stationary state or in a moving state, and to detect at least two moving time periods of the inertial sensing input apparatus, and a first instant and a second instant in each of the moving time periods detected, wherein each of the moving time periods is from the first instant when the inertial sensing input apparatus changes from the stationary state to the moving state, to the second instant when the inertial sensing input apparatus changes from the moving state to the stationary state;
storing the first instant, the second instant and the motion signal of the inertial sensing input apparatus in each of the moving time periods by a data storage module;
when the second instant of the K^{th} moving time period being detected by the state determination module, outputting the K motion signals to an attitude estimation module by the data storage module, estimating a rotational attitude of the inertial sensing input apparatus based on the motion signal in each of the moving time periods by the attitude estimation module, wherein K is a set value and is an integer larger than two or equal to two;
transforming the K relative accelerations to K absolute accelerations based on the K rotational attitudes by a coordinate transformation module;
eliminating the gravitation effect from the K absolute accelerations by a gravity elimination module;
calculating a velocity and a displacement of the inertial sensing input apparatus in each of the moving time periods based on the K gravity-eliminated absolute accelerations, the K first instants and the K second instants by an integral operation module;
calculating a moving trajectory of the inertial sensing input apparatus in the K moving time periods based on the K first instants, the K second instants, the K velocities and the K displacements by a trajectory modification module, and performing a modification procedure onto the moving trajectory; and
removing an auxiliary trajectory in the K^{th} moving time period from the modified moving trajectory by a trajectory removal module in order to produce a primary trajectory.
